(19) United States
(12) Patent Application Publication
(10) Pub. No.: US 2026/0041107 A1
(43) Pub. Date: Feb. 12, 2026

(54) AUGER-STYLE LIQUID TREATMENT TANKS WITH INSTRUMENTATION

(71) Applicant: Morris & Associates, Inc., Garner, NC (US)

(72) Inventors: John P. Shell, Raleigh, NC (US); David H. Macaluso, Benson, NC (US); Kimberly L. Ingram, Goldsboro, NC (US); Terry A. Wright, Cary, NC (US)

(21) Appl. No.: 19/291,366

(22) Filed: Aug. 5, 2025

Related U.S. Application Data
(60) Provisional application No. 63/680,928, filed on Aug. 8, 2024.

(51) Int. Cl. A23B 4/26; A23B 2/792; B65G 33/02

(52) U.S. Cl. CPC A23B 4/26; A23B 2/792; B65G 33/02; B65G 2201/0202

(57) ABSTRACT

Disclosed are various embodiments of an auger-style treatment tank equipped with instrumentation. In one embodiment, an auger treatment tank includes an auger configured to rotate within treatment liquid in the auger treatment tank. The auger includes an auger shaft and at least one auger flight coupled to and helically disposed about the auger shaft. The auger treatment tank also includes one or more sensors configured to provide data directly or indirectly indicating a torque transmitted to the auger to effect rotation.

### CROSS-REFERENCE TO RELATED APPLICATIONS

This application claims priority from U.S. Provisional Application No. 63/680,928, filed on Aug. 8, 2024, which application is hereby incorporated in its entirety by reference in this application.

### BACKGROUND

In many industrial processes including food preparation, products are treated by immersion in various treatment liquids. For instance, warm products can be chilled by immersion in cold water, cheese curd can be cured by immersion in brine, or food products can be immersed in an antimicrobial solution to reduce microbial contamination. An auger-style liquid treatment tank can include a horizontal semi-cylindrical tank and an auger or screw extending between an inlet end and an outlet end of the tank with the outer edge of the auger extending toward the semi-cylindrical wall. The tank can contain a body of liquid (e.g., water) up to a liquid level, which liquid has properties such as temperature and/or chemical content suitable for the treatment intended for a product, such as poultry carcasses, cheese curd, or other products. For example, the liquid may be above, below, or at a certain temperature to warm, chill, or maintain the temperature of the product in various scenarios. Further, the liquid may contain a chemical disinfectant. In some examples, the temperature and chemical content may be selected to treat the product so as to reduce or inhibit microbial growth. In other examples, the liquid is used for chilling, cooking, brining, curing, marinating, or effecting other changes in the product. Conventional auger-style treatment tanks are entirely manually controlled, generally by experienced operators who have a heuristic feel for how best to operate the system. Unfortunately, even experienced operators can mistakenly ignore or fail fully to consider various operational parameters or can simply be distracted by other duties and responsibilities. In some cases, experienced operators can be unavailable, and novice operators can improperly or sub-optimally operate the treatment tank. Accordingly, manual operation can lead to non-optimal product throughput, inadequate product treatment, damage to product, damage to the treatment tank or associated systems, or even potential operator injury.

### BRIEF SUMMARY

These and other features, aspects, and advantages of the disclosure will be apparent from a reading of the following detailed description together with the accompanying drawings, which are briefly described below. The disclosure includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed disclosure, in any of its various aspects and embodiments, should be viewed as intended to be combinable unless the context clearly dictates otherwise.

A first example embodiment of an auger treatment tank, comprising: an auger configured to rotate within treatment liquid in the auger treatment tank, the auger comprising at least one auger flight coupled to and helically disposed about an auger shaft; one or more sensors configured to provide data directly or indirectly indicating a torque transmitted to the auger to effect rotation; and at least one processor configured to at least partially control operation of the treatment tank and to at least: determine a value of an auger-torque-indicating parameter based at least in part on the data received from the one or more sensors; determine an anomalous stress parameter for the auger treatment tank based at least in part on a current operating condition and the value of the auger-torque-indicating parameter; and automatically perform an action based at least in part on the anomalous stress parameter, the action comprising at least one of: issuing a warning or alarm associated with the anomalous stress parameter, modifying operation of the auger treatment tank to ameliorate the anomalous stress parameter, or any combination thereof.

The example embodiment of the auger treatment tank of any preceding example embodiment or any combinations of preceding example embodiments, wherein the at least one processor is further configured to at least: determine a rate of change in the value of the torque-indicating parameter; and determine the anomalous stress parameter for the auger treatment tank based at least in part on the rate of change of the value of the torque-indicating parameter.

The example embodiment of the auger treatment tank of any preceding example embodiment or any combinations of preceding example embodiments, wherein the action comprises generating a control output corresponding to at least one of an auger motor speed, an unloader motor speed, an agitation flow control valve, a circulation pump speed, a transfer pump control, a liquid supply valve control, a drain valve control, a weir actuator control, or any combination thereof.

A second example embodiment of an auger treatment tank for treating a product by immersion in a treatment liquid, comprising: an unloader configured to lift treated product out of the treatment tank; one or more sensors configured to provide data directly or indirectly indicating a torque transmitted to the unloader to effect movement; and at least one processor configured to at least partially control operation of the treatment tank and to at least: determine a value of an unloader-torque-indicating parameter based at least in part on the data received from the one or more sensors; determine an anomalous stress parameter to the auger treatment tank based at least in part on a current operating condition and the value of the unloader-torque-indicating parameter; and automatically perform an action based at least in part on the anomalous stress parameter, the action comprising at least one of: issuing a warning or alarm associated with the anomalous stress parameter, modifying operation of the auger treatment tank to ameliorate the anomalous stress parameter, or any combination thereof.

The example embodiment of the auger treatment tank of any preceding example embodiment or any combinations of preceding example embodiments, wherein the at least one processor is further configured to at least: determine a rate of change in the value of the unloader-torque-indicating parameter; and determine the anomalous stress parameter for the auger treatment tank based at least in part on the rate of change of the value of the unloader-torque-indicating parameter.

The example embodiment of the auger treatment tank of any preceding example embodiment or any combinations of preceding example embodiments, wherein the action comprises generating a control output corresponding to at least one of an auger motor speed, an unloader motor speed, an agitation flow control valve, a circulation pump speed, a transfer pump control, a liquid supply valve control, a drain valve control, a weir actuator control, or any combination thereof.

A third example embodiment of an auger treatment tank for treating a product by immersion in a treatment liquid, comprising: an auger configured to rotate within the treatment liquid in the auger treatment tank, the auger comprising at least one auger flight coupled to and helically disposed about an auger shaft; one or more auger-torque-indicating sensors configured to provide data directly or indirectly indicating a torque transmitted to the auger to effect rotation; and at least one processor configured to at least: determine a value of an auger-torque-indicating parameter based at least in part on the data received from the one or more auger-torque-indicating sensors; and determine a treatment liquid level setpoint for the auger treatment tank based at least in part on the value of the auger-torque-indicating parameter.

The example embodiment of the auger treatment tank of any preceding example embodiment or any combinations of preceding example embodiments, in which the at least one processor is further configured to automatically adjust the amount of treatment liquid in the auger treatment tank to achieve the treatment liquid level setpoint.

The example embodiment of the auger treatment tank of any preceding example embodiment or any combinations of preceding example embodiments, wherein: the auger treatment tank further comprises one or more liquid-level-indicating sensors configured to provide data directly or indirectly indicating a treatment liquid level in the auger treatment tank; and the at least one processor is further configured to at least: determine a current treatment liquid level in the auger treatment tank based at least in part on the data received from the one or more liquid-level-indicating sensors; and determine the treatment liquid level setpoint for the auger treatment tank based at least in part on the current treatment liquid level.

The example embodiment of the auger treatment tank of any preceding example embodiment or any combinations of preceding example embodiments, wherein: the auger treatment tank further comprises means to determine a quantity of product resident in the auger treatment tank; and the at least one processor is further configured to at least: determine a value of a parameter indicating the quantity of product based at least in part on the means to determine the quantity of product; and determine the treatment liquid level setpoint for the auger treatment tank based at least in part on the value of the parameter indicating the quantity of product.

A fourth example of an auger treatment tank for treating a product by immersion in a treatment liquid, comprising: an unloader configured to move within the treatment liquid in the auger treatment tank and to lift treated product out of the treatment tank; an auger configured to rotate within the treatment liquid in the auger treatment tank and to convey the product through the treatment liquid toward the unloader, the auger comprising at least one auger flight coupled to and helically disposed about an auger shaft; means for determining a rate at which product is being unloaded from the auger treatment tank; and at least one processor configured to at least: control a speed of rotation of the auger; determine an unloading rate at which product is being unloaded from the auger treatment tank based at least in part on the means provided; and automatically adjust the speed of rotation the auger to control a rate at which product is pushed toward the unloader based at least in part on the unloading rate at which product is being unloaded.

The example embodiment of the auger treatment tank of any preceding example embodiment or any combinations of preceding example embodiments, wherein: the means for determining the unloading rate at which product is being unloaded from the auger treatment tank comprises one or more unloader-torque-indicating sensors configured to provide data directly or indirectly indicating a torque transmitted to the unloader to effect movement; and the at least one processor is further configured to: determine a value of an unloader-torque-indicating parameter based at least in part on the data received from the one or more unloader-torque-indicating sensors; and determine the unloading rate at which product is being unloaded from the auger treatment tank based at least in part on the value of the unloader-torque-indicating parameter.

The example embodiment of the auger treatment tank of any preceding example embodiment or any combinations of preceding example embodiments, wherein: the means for determining the unloading rate at which product is being unloaded from the auger treatment tank comprises one or more weight-indicating sensors configured to weigh the product as or after it is unloaded from the auger treatment tank; and the at least one processor is further configured to determine the unloading rate at which product is being unloaded from the auger treatment tank based at least in part on data received from the one or more weight-indicating sensors.

The example embodiment of the auger treatment tank of any preceding example embodiment or any combinations of preceding example embodiments, wherein: the means for determining the unloading rate at which product is being unloaded from the auger treatment tank comprises one or more sensors configured to count a number of units of product as or after the product is unloaded from the auger treatment tank; and the at least one processor is further configured to determine the unloading rate at which product is being unloaded from the auger treatment tank based at least in part on data received from the one or more counting sensors.

A fifth example embodiment of an auger treatment tank for treating a product by immersion in a treatment liquid, comprising: an unloader configured to remove treated product from the auger treatment tank; an auger configured to rotate within the treatment liquid in the auger treatment tank and to convey the product through the treatment liquid toward the unloader, the auger comprising at least one auger flight coupled to and helically disposed about an auger shaft; means for determining a temperature of product as or immediately after it is unloaded from the auger treatment tank; and at least one processor configured to at least: control a speed of rotation of the auger; measure, based at least in part on the means for determining a temperature of product, the temperature of product as the product is unloaded or immediately after the product is unloaded from the auger treatment tank; and automatically adjust, in response to measuring the temperature of the product, the speed of rotation of the auger to control a conveyance rate at which product is conveyed toward the unloader.

The example embodiment of the auger treatment tank of any preceding example embodiment or any combinations of preceding example embodiments, wherein: the means for determining the temperature of the product comprises one or more infrared temperature sensors configured to sense product temperature; and the at least one processor is further configured to determine the temperature of the product based at least in part on data received from the one or more infrared temperature sensors.

The example embodiment of the auger treatment tank of any preceding example embodiment or any combinations of preceding example embodiments, wherein: the means for determining the temperature of the product comprises insertion of a temperature sensor into the product and recording a measurement; and the at least one processor is further configured to determine the temperature of the product based at least in part on recorded data received or identified based at least in part on the inserted temperature sensor.

The example embodiment of the auger treatment tank of any preceding example embodiment or any combinations of preceding example embodiments, wherein the one or more sensors comprises at least one strain gauge coupled to the auger drive shaft.

The example embodiment of the auger treatment tank of any preceding example embodiment or any combinations of preceding example embodiments, wherein the one or more sensors comprises at least one current sensor that measures a drive motor current for the auger.

The example embodiment of the auger treatment tank of any preceding example embodiment or any combinations of preceding example embodiments, wherein: the auger treatment tank further comprises one or more sensors configured to provide data related to the operating condition of the auger treatment tank; and the at least one processor is further configured to at least: determine the operating condition of the auger treatment tank and an expected value of the auger-torque-indicating parameter; and determine the anomalous stress parameter based at least on comparison of the value of the auger-torque-indicating parameter and the expected value of the auger-torque-indicating parameter.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a perspective view of an auger treatment tank configured to adjust the temperature, reduce microbial contamination, or effect other changes in the product according to various embodiments.

FIG. 2 is a sectional view of the auger treatment tank of FIG. 1.

FIG. 3 is an outlet end view of the auger treatment tank of FIG. 1 in which some elements have been partially or completely removed to more clearly illustrate operation of the unloader.

FIG. 4 illustrates the inlet end of the auger treatment tank of FIG. 1 in additional detail.

FIG. 5 is an outlet end view of the auger treatment tank of FIG. 1 with additional detail as compared to the outlet end view of FIG. 3.

FIG. 6 is a longitudinal side view of the auger treatment tank of FIG. 1 with ancillary components.

FIG. 7A is a longitudinal section view of the auger treatment tank of FIG. 1 illustrating the operation of the auger treatment tank of FIG. 1.

FIG. 7B is a section view of a belt unloader used in alternative embodiments of the auger treatment tank of FIG. 1.

FIG. 8 illustrates a section view of an adjustable weir used in the overflow box of the auger treatment tank of FIG. 1 according to various embodiments.

FIGS. 9 and 10 are drawings illustrating examples of relationships among parameters and their potential use in controlling the auger treatment tank of FIG. 1.

FIG. 11 is a schematic block diagram of a networked environment according to various embodiments of the present disclosure.

FIG. 12 is a schematic block diagram that provides one example illustration of a computing environment employed in the networked environment of FIG. 11 according to various embodiments of the present disclosure.

FIGS. 13-17 are flowcharts illustrating examples of functionality implemented as portions of a treatment tank control application executed in a computing environment in the networked environment of FIG. 11 according to various embodiments of the present disclosure.

### DETAILED DESCRIPTION

The present disclosure relates to an auger-style treatment tank that includes instrumentation and controls to optimize treatment objectives. Conventional auger-style treatment tanks lack this instrumentation and are entirely manually controlled, generally by experienced operators who have a heuristic feel for how best to operate the system. Unfortunately, even experienced operators may mistakenly ignore or fail fully to consider various operational parameters or may simply be distracted by other duties and responsibilities. In some cases, experienced operators may be unavailable, and novice operators may improperly or sub-optimally operate the treatment tank. Accordingly, manual operation may lead to non-optimal product throughput, inadequate product treatment, damage to product, damage to the treatment tank or associated systems, or even potential operator injury. As will be described, the instrumentation includes monitoring devices and control devices that can be used to optimize the operation of the auger-style treatment tank and provide for improved throughput and better treatment of the product.

In the past, torque limiting devices such as shear pins have been used to protect auger drive components from damage due to excessive torque load on the auger. However, it is possible for localized loads on the auger to cause damage to the auger and particularly to the auger flight while the total auger torque is still below the torque limiter threshold. The current invention solves this problem by providing a more nuanced analysis of auger torque.

In some examples, an auger-style liquid treatment tank can include a horizontal semi-cylindrical tank and an auger or screw extending between an inlet end and an outlet end of the tank with the outer edge of the auger extending toward the semi-cylindrical wall. The tank can be configured to contain a body of liquid up to a liquid level, which liquid can have properties such as temperature and/or chemical content suitable for the treatment intended for a product, such as poultry carcasses, cheese curd, or other products. For example, the liquid can be above, below, or at a certain temperature to warm, chill, or maintain the temperature of the product in various scenarios. Further, the liquid can contain a chemical disinfectant. In some examples, the temperature and chemical content can be selected to treat the product so as to reduce or inhibit microbial growth. In other examples, the liquid can be used for chilling, cooking, brining, curing, marinating, or effecting other changes in the product.

Mechanical components can be provided to rotate the auger about a longitudinal axis approximately collocated with the cylindrical axis of the tank. Such mechanical components can comprise motors, gears, linkages, and/or related devices. The tank can also include an infeed component for loading product into the tank and an unloading component (unloader) as well as components for filling and draining treatment liquid from the tank. The unloader can remove product from the tank by way of components such as rotary paddles (paddlewheel style), belt conveyors, pumps, or other components. The tank can be fitted with components that inject air, treatment liquid or other fluids into the tank below the liquid level in the tank for the purpose of agitating the liquid in the tank and causing it to circulate about the product in the tank.

As the product is treated in the auger treatment tank, the treatment liquid can be consumed and/or the treatment liquid can decline in volume. For example, the product can absorb chemicals in the treatment liquid, which can leave the treatment liquid depleted of such chemicals. Depleted treatment liquid can be removed from the treatment tank and replaced with fresh treatment liquid. In other embodiments, the treatment liquid can be processed to restore potency, for example, by adding additional chemicals to the treatment liquid. The treatment liquid can be processed within the treatment tank or by removing depleted liquid from the treatment tank and returning rejuvenated treatment liquid to the treatment tank.

The product to be treated can be fed into the tank at an inlet end and be immersed in the treatment liquid. Rotation of the auger can move the product along the length of the tank toward an outlet end opposite the inlet end. The product can be agitated within the liquid by the motion of the auger and by circulation induced by the agitating fluid injection. The product can be held within the tank for a period of time. The product can be removed from the tank at the outlet end.

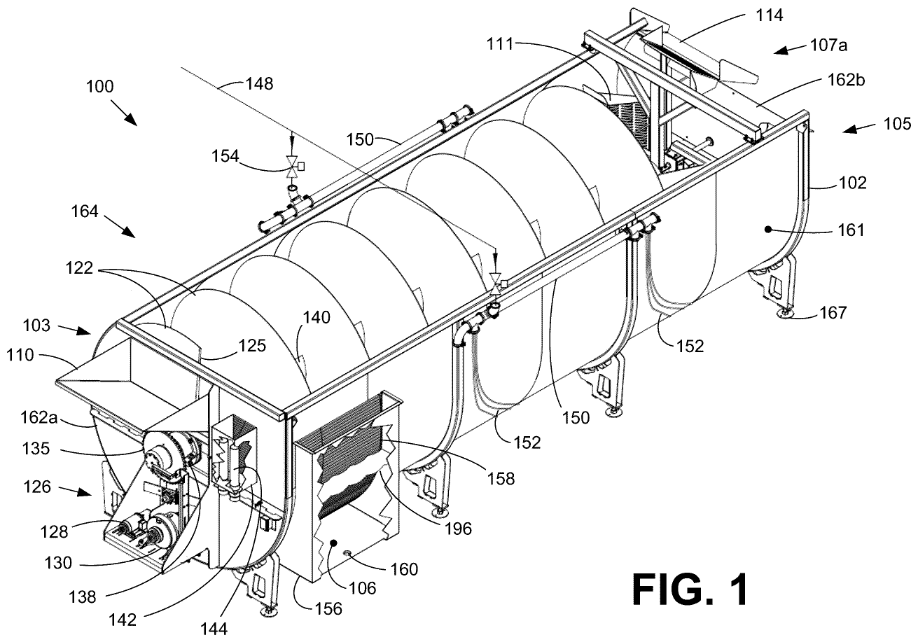

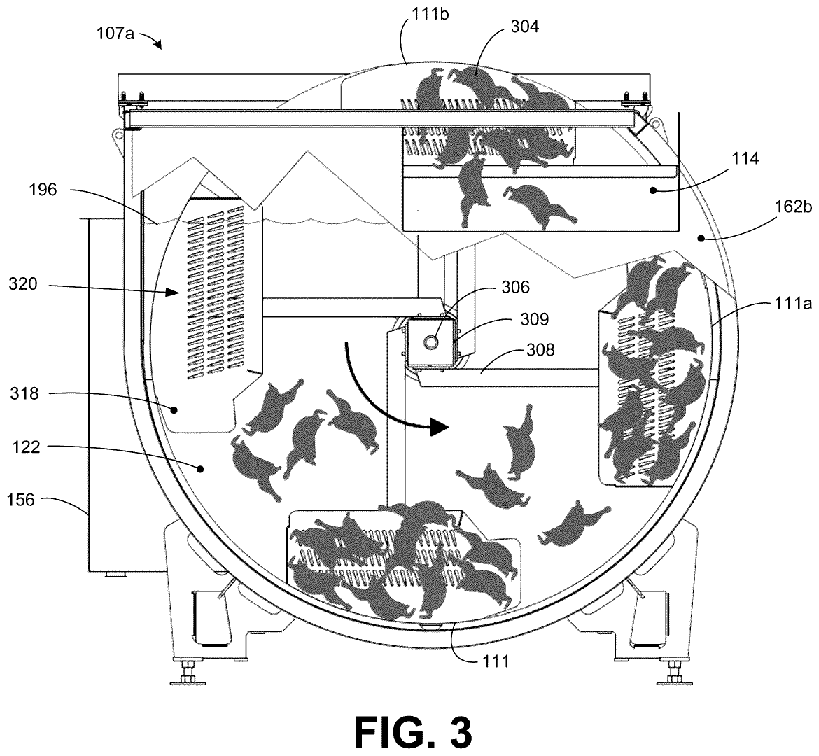

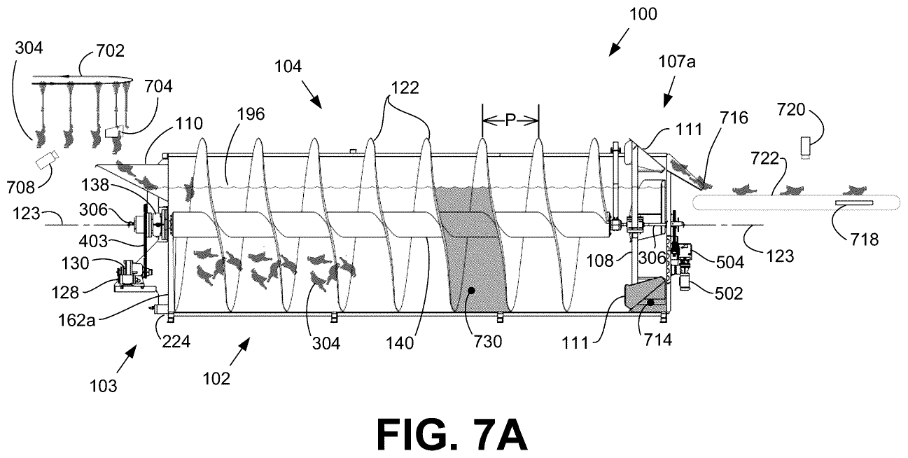

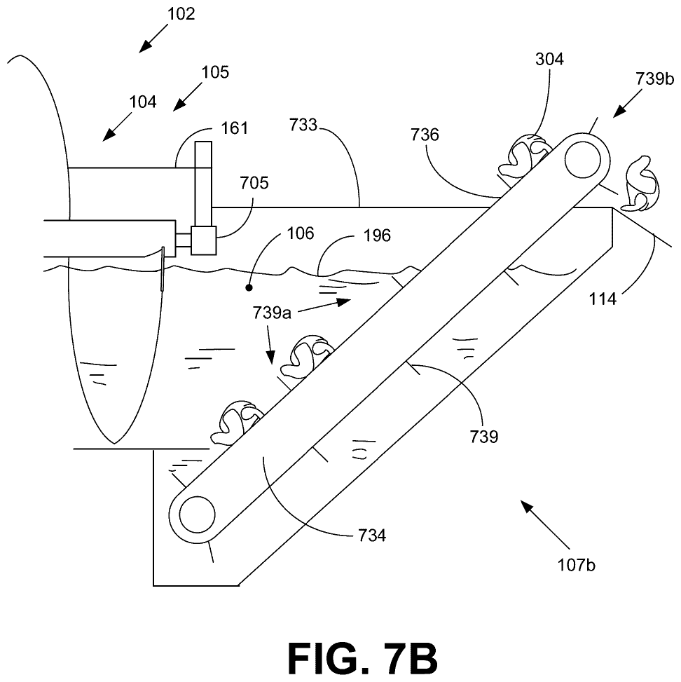

The treatment system can employ an external heat exchanger to alter the temperature of treatment liquid in the treatment tank. Typically, liquid is removed from one end of the tank and pumped through a heat exchanger where it is heated or chilled before being returned to a different area of the tank. In other embodiments, treatment liquid temperature is adjusted in situ by means such as heaters attached to the outside of the tank wall. Other approaches to temperature management can be used in other embodiments. Referring now in more detail to the drawings, in which like numerals indicate like parts throughout the several views, FIG. 1 is a perspective view of an auger treatment tank 100 configured to treat products, such as eviscerated poultry carcasses, meat, fish, packages of products (e.g., soup packets, beans), and so on. The auger treatment tank 100 generally includes a tank 102 and an auger 104. The tank 102 can be configured to hold a body of treatment liquid 106, such as water that can include other chemicals compatible for reducing microbial contamination or effecting other changes in the product. Product can be introduced into an inlet end 103 of the tank 102—for example by way of an inlet chute 110—and is treated (e.g., temperature adjusted) by the treatment liquid 106 and can have contaminants neutralized before being removed from the outlet end 105 of the tank 102 by way of an unloader 107. A paddlewheel unloader 107a is illustrated in FIG. 1 and further detailed in FIG. 3. In other embodiments, the unloader 107 can be a belt unloader 107b as illustrated in FIG. 7B or other types of unloaders such as unloading pumps or other suitable mechanisms.

As the product is treated in the auger treatment tank 100, the treatment liquid 106 can be consumed and/or the treatment liquid 106 can decline in volume. For example, the product can absorb chemicals from the treatment liquid 106, which can leave the treatment liquid 106 depleted of such chemicals. Depleted treatment liquid 106 can be removed from the treatment tank and replaced with fresh treatment liquid 106. In other embodiments, the treatment liquid 106 can be processed to restore potency, for example, by adding additional chemicals to the treatment liquid 106. The treatment liquid 106 can be processed within the treatment tank 100 or by removing depleted liquid from the treatment tank 100 and returning rejuvenated treatment liquid 106 to the treatment tank 100.

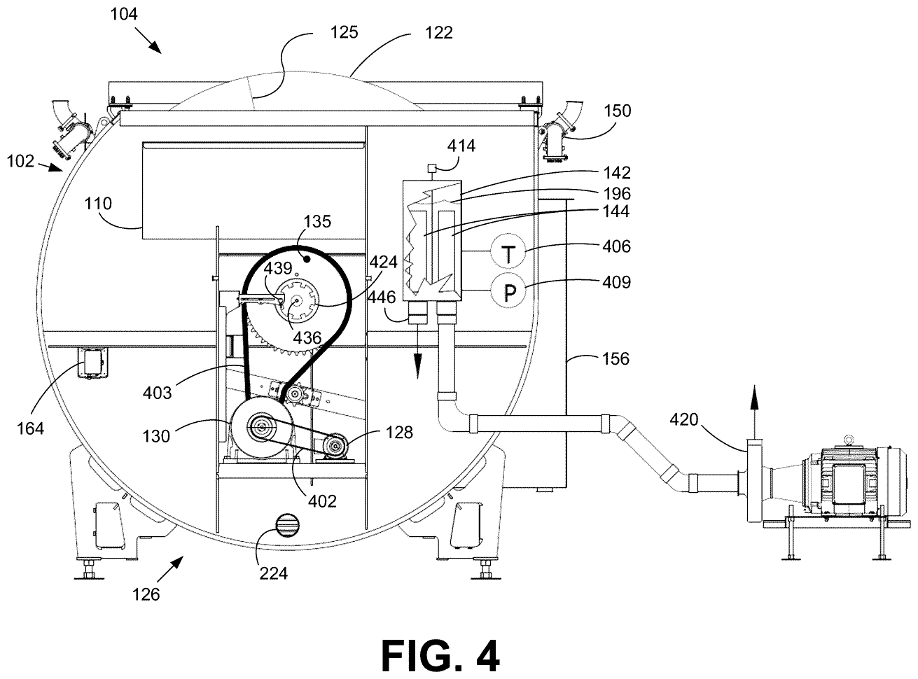

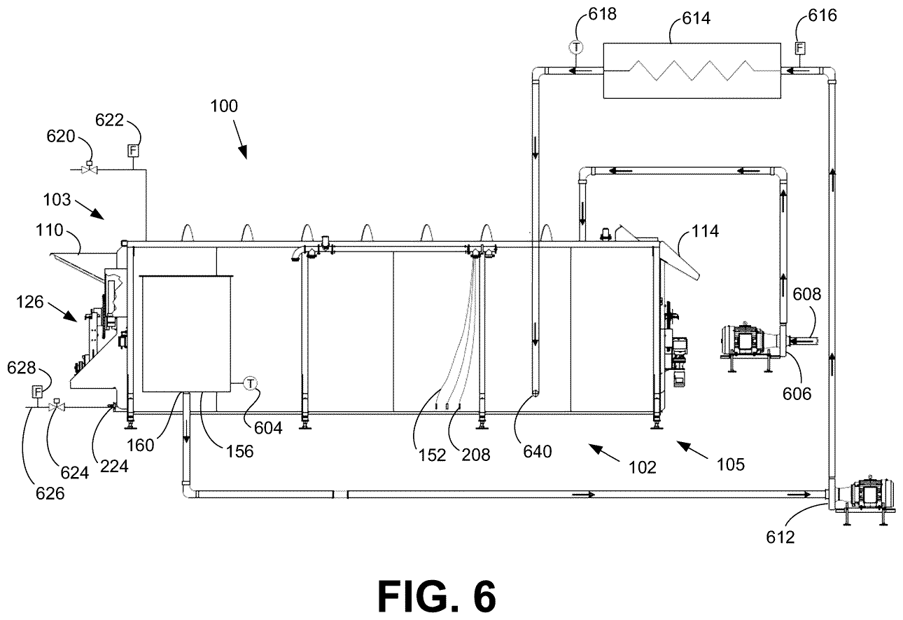

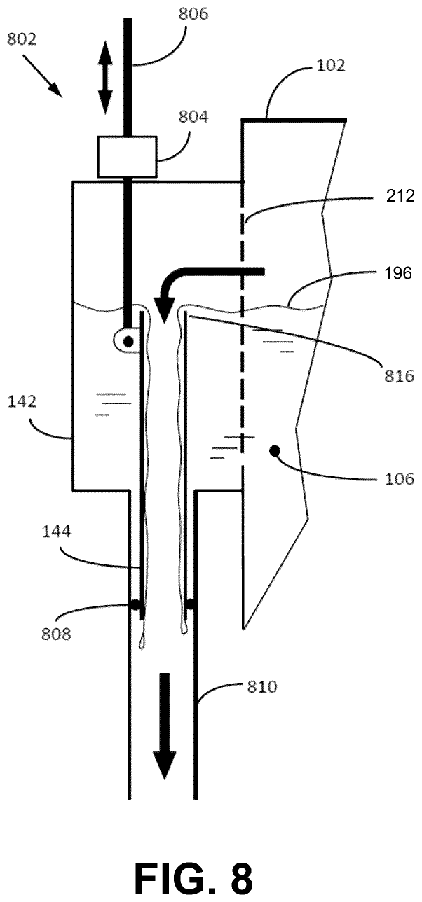

The system can remove treatment liquid 106 from a suction box 156 at the inlet end 103 of the tank 102 by way of a suction port 160. A suction grate 158 allows treatment liquid 106 to pass from the tank 102 to the suction box 156 but prevents product 304 from passing through. Outside the auger treatment tank 100, the temperature or other characteristics of the treatment liquid 106 can be adjusted, and the treatment liquid 106 can be returned into the tank 102 at the outlet end 105. In various embodiments, the treatment liquid 106 can be returned for example over the side of the tank 102 or through a return port 640 (FIG. 6) below the liquid level 196 of the tank 102. The return of treatment liquid 106 at the outlet end 105 of the tank 102 and removal of treatment liquid at the inlet end 103 can create a flow counter to the product as it moves from the inlet end toward the outlet end of the tank. This counter-flow configuration is generally conducive to more effective treatment, however in some circumstances, concurrent flow can be preferred without deviating from the intent of this invention. An overflow box(es) 142 can be positioned at the end of the tank 102 to provide another means for treatment liquid 106 leave the tank 102, with or without provision for return. Additional detail of overflow components is shown in FIGS. 4 and 8.

The auger 104 can include a shaft 140 with at least one flight 122 helically disposed about the shaft and extending radially from the shaft toward the tank wall 161. The flight 122 has a leading edge 125 extending approximately radially from the shaft 140 at the inlet end 103 of the auger which rotates with the auger. The auger 104 can be supported by a drive bearing 138 mounted to the inlet end wall 162a and one or more hanger bearings 705 (FIG. 7B) supported from the upper edges of the longitudinal wall 161. An auger drive 126 (shown in more detail in FIGS. 4 and 7A) can cause the auger 104 to rotate about a longitudinal axis 123 (FIG. 7A). As the auger 104 rotates, it can convey the product 304 in the tank toward an unloader 107 at the outlet end 105 at a conveyance rate proportional to the speed of rotation as in an Archimedes screw. Treatment liquid 106 can flow in the opposite direction through the mass of product in the tank to effect treatment. The rotation of the auger 104 can be relatively slow. For example, the auger 104 can take about 30 seconds to about 6 minutes to complete a revolution. In the space of one revolution, the product can be advanced down the length of the treatment tank by a distance equal to the pitch of the auger. For an auger with a single flight, the pitch (P) can refer to the axial distance from one point on the flight to another point exactly one revolution along the flight as illustrated in FIG. 7A. The pitch is often—but not necessarily—uniform along the length of the auger.

Although the auger 104 is described above as having a specific configuration, a person of skill would appreciate that the auger 104 can have other configurations in other embodiments. For example, the auger 104 can have multiple interlaced flights. The auger drive 126 can be otherwise positioned, including positions in which the auger drive 126 is mounted overhead.

An air supply pipe 148 can supply pressurized air via an air distribution header 150 to a plurality of air hoses 152 that introduce air into the tank 102 to agitate the contents. The air can be controlled by way of the agitation flow control valve 154. In other embodiments, the air flow can be controlled by speed control devices on the air blower(s).

The tank 102 is generally formed from an elongated longitudinal wall 161. The longitudinal wall 161 has a curved bottom portion. In the illustrated embodiment, the longitudinal wall 161 has a side wall on one side that continues the curvature of the bottom portion and a straight vertical side wall on the opposing side. The side walls can increase the height of the tank 102 along the sides. In other embodiments, the longitudinal wall 161 can be approximately semi-cylindrical. Enclosing the longitudinal wall 161 at its edges can be an inlet end wall 162a at the inlet end 103 of the tank 102, and an outlet end wall 162b at the outlet end 105 of the tank 102. A longitudinal axis 123 can extend between the end walls 162 and from the inlet end 103 to the outlet end 105 of the tank 102. In the illustrated embodiment, the end walls 162 can be substantially parallel to each other, although other configurations are possible.

The tank 102 can have a variety of shapes, sizes, and volumes, and can be formed from a variety of materials. In one non-limiting example, the tank 102 can have a length between the end plates of about 20 feet up to about 120 feet, a width between about 7 feet and 12 feet, and a height between about 6 and 11 feet. In such an example, a capacity of the tank 102 can be between about 150 and 450 gallons per linear foot. In other examples, a length of the tank 102 can be between about 2 and 40 feet, and a width of the tank 102 can be between about 1 and 12 feet. An example of a material that can be used to form the walls of the tank 102 is stainless steel. However, other materials and shapes can be used.

In some embodiments, the tank 102 can be configured to be slightly sloped between the end walls 162 to facilitate draining liquid from the tank and to accommodate a treatment liquid gradient that keeps treatment liquid flowing through the mass of product in the tank and through and around the auger flights 122. For example, the longitudinal wall 161 of the tank 102 can tilt slightly downward toward the inlet end. Alternatively, a plurality of adjustable leveling feet 167 that support the tank 102 can be adjusted so that the outlet end 105 is slightly higher than the inlet end 103.

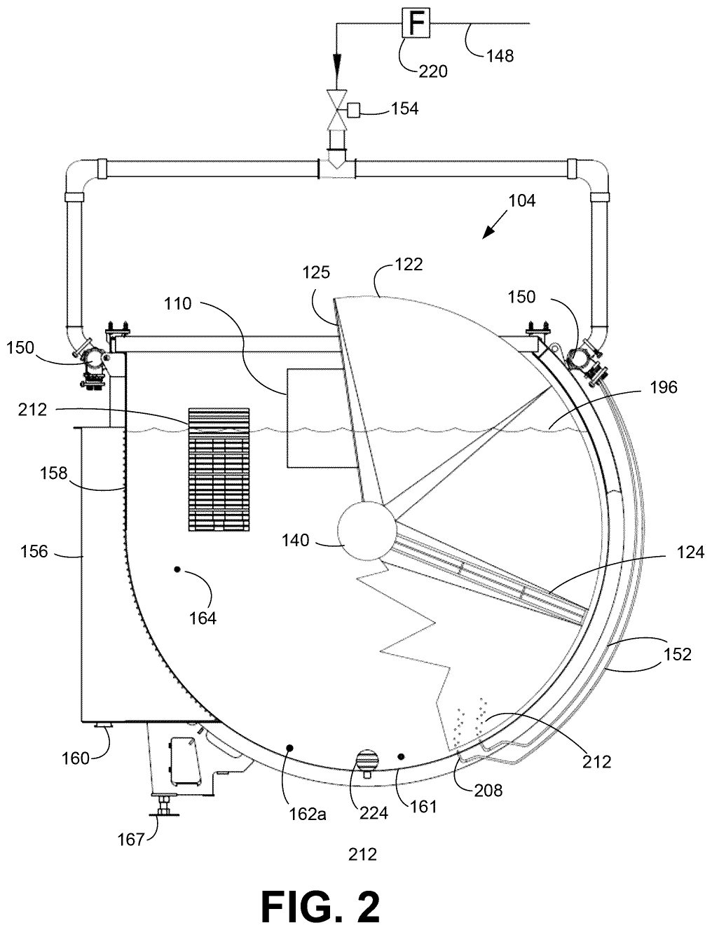

FIG. 2 is a sectional view of the auger treatment tank 100 looking toward the inlet end 103. The auger flights 122 of the auger 104 are shown to extend from the auger shaft 140 toward the concave inner surface of the longitudinal wall 161 of the tank 102, so that the auger flight 122 is positioned closely adjacent the concave longitudinal wall 161. In some embodiments, the space between the auger flight 122 and the longitudinal wall 161 can have a predetermined size or distance small enough to discourage the product from passing through the space. The auger flight 122 can be pierced by flow ports 124 sized and shaped to allow treatment liquid 106 to pass through but preventing product from passing through. In this view, the leading edge 125 is shown in a nearly vertical position above the auger shaft 140. As the auger 104 rotates, the leading edge 125 can sweep to the side and then below the auger shaft 140.

The auger treatment tank 100 can include a plurality of agitation flow nozzles 208 coupled to the air hoses 152, which are fed by the air header 150. The agitation flow control valve 154 can regulate the amount of air and/or pressure delivered to the agitation flow nozzles 208. Alternatively, the speed of blowers supplying the air can be changed to control air flow. The flow of agitation air can be measured by a flow sensor 220. The agitation flow nozzles 208 introduce rapidly rising air bubbles 212 into the treatment liquid 106. The air bubbles tend to disturb the product and to create turbulence in the treatment liquid 106 surrounding the product, enhancing contact between the product and the treatment liquid 106. Agitation can also break up clumps or piles of product that can form as the auger pushes product through the treatment tank 100. The agitation flow nozzles 208 can be positioned through the longitudinal wall 161 of the tank 102 at intervals along the length of the tank 102. Each interval can include several agitation flow nozzles 208 that are spaced apart around the curved bottom portion. Although not depicted in FIG. 2, an equivalent effect can be achieved by injecting treatment liquid 106 under pressure through the flow nozzles 208 penetrating the longitudinal wall 161 of the treatment tank 100 to enhance circulation of the treatment liquid 106 about the product.

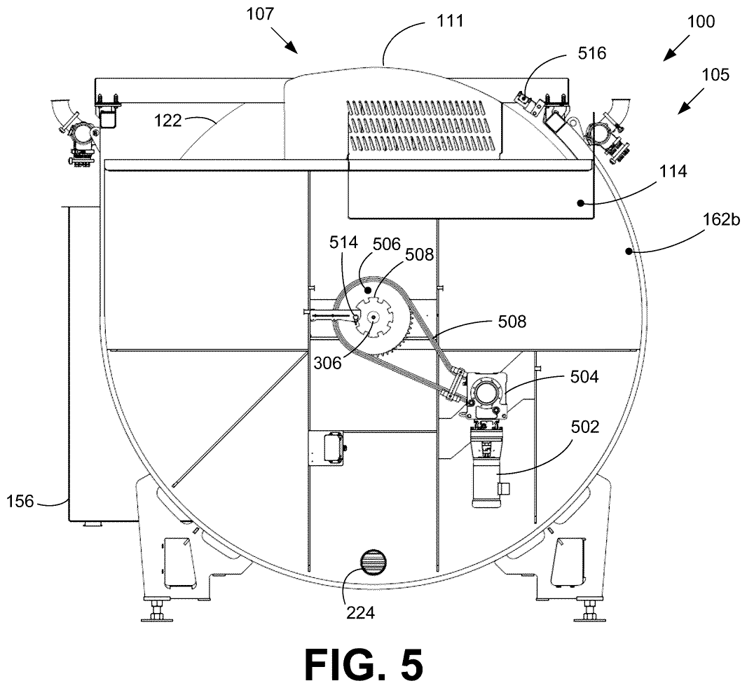

FIG. 3 is an outlet end 105 view of the auger treatment tank 100 in which some elements (as shown in more detail in FIG. 5) have been partially or completely removed to more clearly illustrate operation of the paddlewheel unloader 107a. The outlet end wall 162b is shown partially removed to reveal the paddlewheel unloader 107a which can include an unloader hub 309 connected to a plurality of radiating arms 308 each supporting a paddle 111 at its distal end. The paddlewheel unloader 107a can rotate about an axis 123 (FIG. 7A) usually coincident with the axis of the auger. As the paddlewheel unloader 107a rotates, the paddles 111 can move product 304 through the treatment liquid 106 and lift the product out of the tank 102 from a lifting position 111a to an unloading position 111b where the product 304 is deposited onto a discharge chute 114. The paddlewheel unloader 107a can be rotated by means of an unloader shaft 306 connected to the unloader hub 309 which shaft penetrates the outlet end wall 162b.

The unloader paddles 111 can include a scoop 318 to direct product to the unloader paddle 111, and the unloader paddle 111 can include a plurality of perforations 320 that can be used to drain the treatment liquid 106 away from the product. While a variety of assemblies can be employed, in the illustrated embodiment the unloader 107 can include a rotating paddlewheel unloader 107a.

FIG. 4 illustrates the inlet end 103 of the auger treatment tank 100 including the auger drive 126 in additional detail. The auger drive 126 can include an auger motor 128 that can operate a speed reducer 130, which in turn can rotate a sprocket 135 connected to a drive shaft 436 that can rotate in a bearing 138 (see FIG. 1) to turn the auger 104. The auger motor 128 can be an electric motor, hydraulic motor or other device that imparts the motion to the auger 104. Additional components shown in FIG. 4 can include a drive belt 402 coupling the auger motor 128 to the auger speed reducer 130 and a chain 403 coupling the speed reducer 130 to the drive sprocket 135. The auger treatment tank 100 can be instrumented with a rotation sensor 439 to sense and monitor the rotation of the auger 104.

The overflow box 142 can be instrumented with a treatment liquid temperature sensor 406 and a pressure sensor 409, where the pressure measurement from the pressure sensor 409 can be indicative of the liquid level 196 in the tank 102. A level sensor 414 can detect the current liquid level 196 in the overflow box 142, which can be relative to the overflow standpipe 144. For example, the level sensor 414 can be a single-point sensor such as a float switch or an analog level measurement such as an ultrasonic sonar type sensor or a capacitive level sensor. Both the pressure sensor 409 and the level sensor 414 can be considered a level-indicating sensor, which can be used to indicate the liquid level 196 in the tank 102.

The auger treatment tank 100 can also be instrumented with a low level sensor 164 positioned at an elevation at which the low level sensor 164 can indicate that the corresponding treatment liquid level 196 of treatment liquid 106 is too low for standard operation. Problems that can occur due to a low level of the treatment liquid 106 can include inadequate treatment of the product 304, damage to the product, damage to the auger 104 or unloader 107 or other components of the auger treatment tank 100, improper unloading of the product, and so forth.

The overflow box 142 can be fitted with one or more stand pipes 144 to set an upper limit on the height of the water level 196. When the water level 196 exceeds the height of the stand pipe 144, water can flow over the lip of the stand pipe and drain out through an overflow drain 446 or to a transfer pump 606 (see FIG. 6). A drain port 224 on the tank 102 can be provided in order to drain the tank 102 completely.

FIG. 5 is an outlet end 105 view of the auger treatment tank 100 with additional detail as compared to FIG. 3. In particular, the unloader drive motor 502 operates the unloader speed reducer 504, which can drive the unloader sprocket 506 by way of a drive chain 508 (or belt). The unloader sprocket 506 can in turn operates the unloader shaft 306. A rotation sensor 514 can be provided in order to monitor the unloader rotation by way of the rotation of the cogged disk 510 attached to the unloader shaft 306. A paddle proximity sensor 516 can be used to sense the passing of unloader paddles 111 as the unloader 107 rotates. Another drain port 224 is also shown.

FIG. 6 is a longitudinal side view of the auger treatment tank 100 with ancillary components. A temperature sensor 604 (also called a temperature-indicating sensor) can be provided on or in the suction box 156 to sense the liquid temperature in the suction box 156. A transfer pump 606 can be provided to transfer treatment liquid 106 from a downstream tank via line 608 into the tank 102, and a flow monitor 610 can monitor the rate and/or pressure of this flow. A circulation pump 612 can transfer treatment liquid 106 from the suction port 160 of the suction box 156 to a heat exchanger 614 where the liquid is heated or cooled. A flow monitor 616 can monitor the rate and/or pressure of this flow, and a temperature sensor 618 can monitor the controlled temperature of the liquid output from the heat exchanger 614. Liquid 106 can be returned to the tank 102 at a return port 640 near the outlet end 105. A liquid supply valve 620, regulates the admission of fresh treatment liquid 106 into the tank 102, and a makeup flow monitor 622 can monitor the rate and/or pressure of this flow. The liquid supply valve can be a solenoid valve, a motorized valve or other type of controllable valve or it can be a manually operated valve. A drain valve 624, which can be a manually operated or power operated valve, controls the disposal of liquid to a waste line 626 or to a floor drain. A drain flow monitor 628 can monitor the rate and/or pressure of this flow.

FIG. 7A is a longitudinal section view of the auger treatment tank 100 illustrating the operation of the auger treatment tank 100. In this non-limiting example, the product 304 arrives on a shackle line 702 and is dismounted from the shackle line 702 by way of a product dismount device 704 and deposited into the tank 102 at the product inlet end 103. Examples of alternatives to the shackle line 702 for delivery of the product can include belts, chutes, sluice troughs, pipe, and other such means.

The quantity of product 304 delivered to or removed from the auger treatment tank 100 can be detected by a product sensor 708. The product sensor 708 can be a proximity sensor, an optical sensor, a camera with image recognition capability or other type of sensor to detect the presence of product 304. Alternatively, a belt scale 718 (also called a weight-indicating sensor) can include a load cell in a conveyor 722 to measure the weight of the product 304 entering or leaving the auger treatment tank 100.

The auger 104 can be rotated about the axis 123 to advance product toward the outlet end 105. The structure of the auger can create at least one compartment 730 within the auger treatment tank 100 which compartment travels along the length of the tank 102 as the auger 104 rotates. The compartment 730 can be bounded by a section of auger flight 122 on the upstream side of the compartment 730 and another section of flight 122 on the downstream side. The compartment 730 is further bounded by the longitudinal wall 161 of the tank 104. Product deposited into a compartment 730 at the inlet end 103 of the tank 102 can generally stay in the same compartment as that compartment travels toward the outlet end 105.

The product 304 ultimately arrives at the product discharge end 105 and is lifted out of the tank 102 by the unloader paddles 111, which can rotate with the paddlewheel unloader 107a and unloader shaft 306. The area 714 shows a volume of product captured by the unloader paddle 111 that is then lifted out of the tank 102. The product 304 can be lifted out of the tank 102 and deposited into the discharge chute 114, where it falls out of the chute at 716 and onto a product discharge conveyor 722. An infrared temperature sensor 720 can measure the temperature of the product 304 at this time, after it has been heat adjusted by the auger treatment tank 100.

FIG. 7B is a section view of a belt unloader 107b used in alternative embodiments of the auger treatment tank 100. The belt unloader 107b can be used in place of the paddlewheel unloader 107a shown in FIG. 1. In this example, product can be fed to the outlet end 105 of the tank 102 by rotation of the auger 104 and into a compartment 733 that houses a conveyor assembly 734. Product 304 can settle on the belt 736 of the conveyor assembly 734 and can be lifted out of the treatment liquid 106 and deposited onto a discharge chute 114 or possibly another conveyor. Cleats 739 (transverse ribs) attached to the belt 736 keep the product 735 from sliding down the incline of the belt 736. In alternative embodiments, the conveyor assembly 734 can be turned 90 degrees from the orientation shown in order to discharge product toward the side of the tank 102. In another embodiment, a fluidized unloader can be used to convey a mixture of product and treatment liquid to a location outside the tank 102. In yet another embodiment, a rotating picker can be used as an unloader.

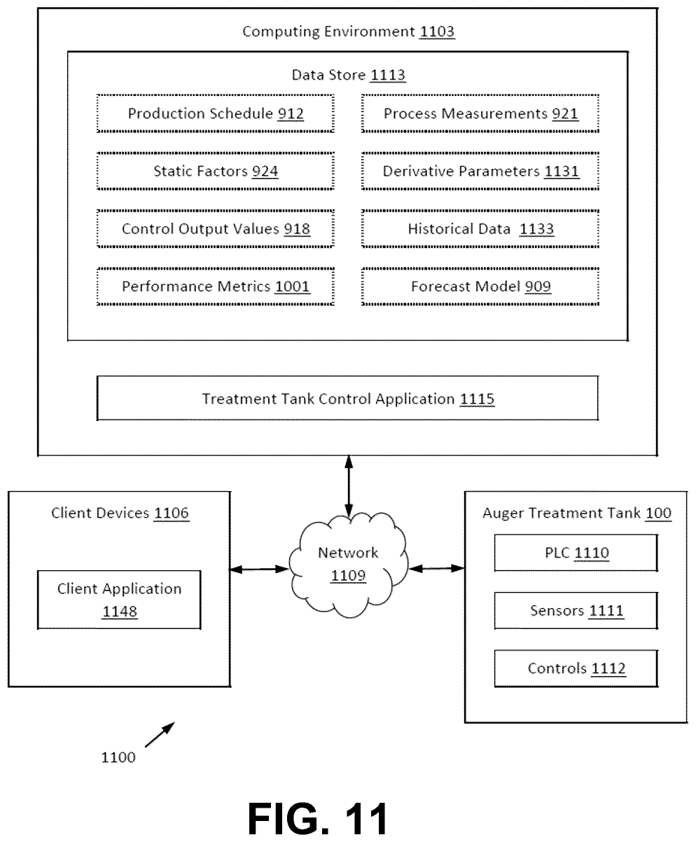

FIG. 8 illustrates a section view of an adjustable weir used in the overflow box 142. A linear actuator 802 can include a power unit 804 that moves a lead screw 806 up and down as desired, which in turn can move the standpipe 144 up and down in the overflow box 142. A seal 808 can impound the liquid from exiting the overflow box 142 via the drain pipe 810, while allowing the standpipe 144 to move up and down. A grate 212 can be used to separate the product from the overflow box 142, while allowing the treatment liquid 106 to pass through. When the liquid level 196 exceeds the upper edge 816 of the standpipe 144, the treatment liquid 106 can exit down the drain pipe 810. The linear actuator 802 can take the form of a jack-screw, a rack and pinion, a mechanical linkage such as a 4-bar linkage, a pneumatic or hydraulic cylinder or other forms that allow the upper edge 816 of the standpipe 144 to be set to different elevations. The linear actuator 802 can be fitted with a position sensor encoder serving as a sensor 1111 (see FIG. 11) to report the position of the standpipe 144. The adjustable weir is shown mounted in an overflow box 142, however, in other embodiments, it can be mounted in other locations such as the suction box while achieving equivalent function and efficacy.

In alternate embodiments, the adjustable weir can comprise a moveable weir plate (not shown) installed in a track adjacent an opening in a wall of the tank 102 or overflow box 142 or suction box 156. A sliding seal prevents liquid in the tank from flowing between the plate and tank wall. The assembly is configured so that liquid from the tank or overflow box can flow over an upper edge of the weir and out of the treatment tank. Thus, the height of the upper edge determines the liquid level 196 in the treatment tank. A linear actuator or rotary actuator moves the plate in a manner that changes the elevation of the upper lip of the weir to adjust the liquid level 196 in the treatment tank 102.

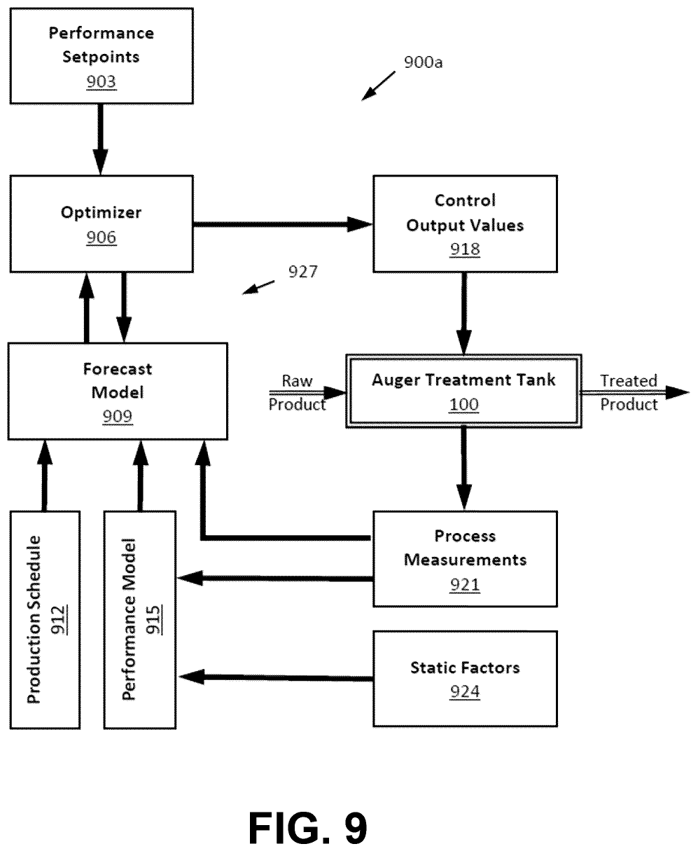

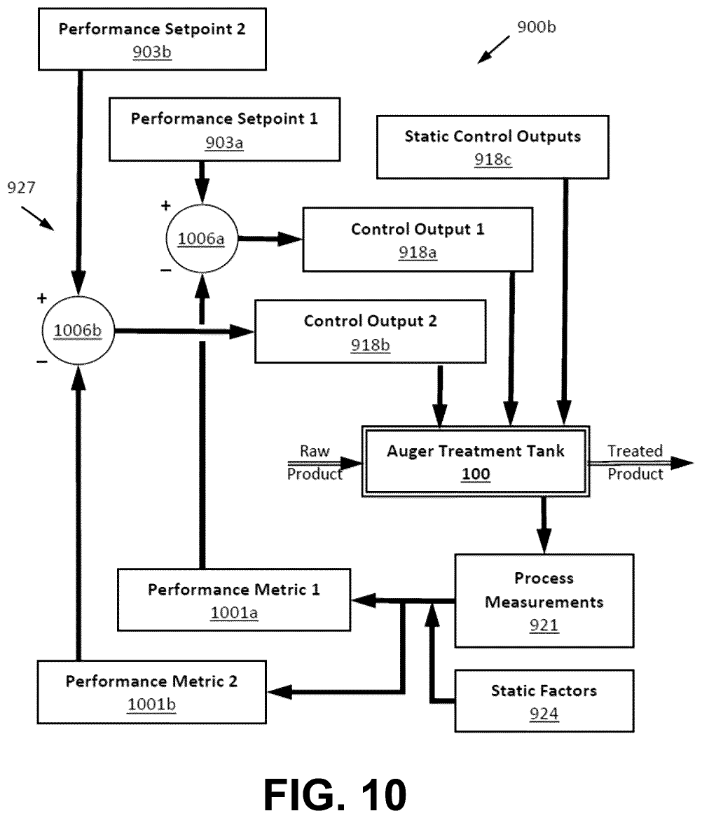

A set of parameters can be defined that characterize the condition of the treatment tank and the product being treated. These parameters can be used in different ways including as performance metrics, control outputs, process measurements, static factors and derivatives. Individual parameters and their uses are further explained herein. The relationships among these parameters and their potential use in controlling the treatment tank are illustrated in FIGS. 9 and 10.

There follows a description of a number of parameters that can be of interest in managing the auger treatment tank 100. It will be appreciated that not all of these parameters will be relevant to every application of an auger treatment tank. Furthermore, additional parameters not described herein can be useful in particular application of an auger treatment tank, and such additional parameters can be incorporated into the structure and methods described herein without deviating from the spirit and intention of the invention.

A parameter characterizing the treatment liquid level 196 in the tank 102 can be used in various ways including as a metric 1001, as a process measurement 921 and as a control output 918. The level can be measured with respect to the auger shaft 140, but other reference elevations can be equally useful (e.g., the elevation of a drain 224 of the tank 102). The liquid level 196 can be maintained at an elevation between the bottom of the auger shaft 140 and 18 inches above the auger shaft, though specific applications can call for a higher or lower liquid level. The liquid level can be slightly lower at the inlet end 103 of the tank 102 than at the outlet end 105 due to flow resistance as the treatment liquid 106 moves through the mass of product and around the edges of the auger. In some embodiments, the liquid level across the whole treatment tank 100 can be characterized by a measurement take at one place, for example at the suction box 156. In other embodiments, liquid level can be monitored at two or more locations along the length of the tank 102 in order to characterize gradient in the liquid level.

The liquid level 196 can be measured directly for example using the level sensor 414. The level sensor 414 can be a radar sensor, ultrasonic sensor, laser sensor, capacitive level sensor, or another type of sensor. Alternatively, the level can be measured indirectly for example using the pressure sensor 409. In some embodiments, it can be useful to detect if the liquid level 196 is less than a certain elevation, for example low level sensor 164 can be a level switch that provides a discrete signal indicating whether the level is above or below the elevation of the low level sensor 164. In yet other embodiments, the liquid level 196 can be inferred from the position (elevation) of an overflow standpipe 144 or adjustable weir.

The liquid level 196 can be manipulated or controlled by the addition or removal of treatment liquid 106 to the auger treatment tank 100. Also, the addition or removal of product 304 to the auger treatment tank 100 can change the liquid level 196 to the extent that the product displaces treatment liquid. There are a number of mechanisms by which treatment liquid can be added or removed from the auger treatment tank 100. Makeup liquid can be added to the tank by way of a liquid supply valve 620, and the liquid added in this manner can be measured by a makeup flow monitor 622. Alternatively, or additionally, treatment liquid 106 can be added to the auger treatment tank 100 by a transfer pump 606 moving liquid from a separate system such as a separate downstream treatment tank. In other embodiments, transfer flow can be affected by gravity flow through channels or pipes and regulated by appropriate valves. Treatment liquid 106 can be removed from the auger treatment tank 100 by way of a drain valve 624 connected to a drain 224 on the tank 102. Flow through the drain valve 624 can be measured by a drain flow monitor 628. Treatment liquid 106 can be removed from the auger treatment tank 100 by way of an overflow standpipe 144 as previously described. Treatment liquid 106 can be removed from the auger treatment tank 100 by a transfer pump 420 moving liquid to a separate system such as a separate upstream treatment tank. Any such flow of treatment liquid 106 into or out of the auger treatment tank 100 can be monitored or measured using appropriate sensors 1111 with the sensor outputs supplied to the control application 1115. Likewise, any flow of product 304 into or out of the auger treatment tank 100 can be monitored or measured using appropriate sensors 1111 with the sensor outputs supplied to the control application 1115. The sensors 1111 can also include other sensors discussed with respect to other figures.

Each of the flows mentioned in the previous paragraph can be regulated by application of appropriate controls 1112. In the case of valves, the flow can be regulated by a solenoid opening or closing the valve, or by a motor operator or pneumatic operator controlling the position of the valve. In the case of pumps, flow can be regulated by turning the pump on or off or by changing the speed of the pump. In the case of an overflow standpipe, flow can be regulated by adjusting the height of the standpipe as with a linear actuator 802. Other means of controlling these flows can be used to similar effect.

An auger-torque-indicating parameter (ATIP) characterizing the torque required to rotate the auger 104 in the treatment liquid 106 in the auger treatment tank 100 can be used as a process measurement 921, it can also be used as a metric 1001 and as a control output 918 in some applications. The auger torque can be measured directly using a variety of sensors 1111. For example, strain gauges can be mounted on the auger drive shaft 436 to measure torque applied to the auger 104. Alternatively, the auger motor 128 can be mounted with a load cell that provides a signal proportional to torque. In other embodiments, the control algorithm can use other quantities such as auger motor 128 current draw (Amps as measured by a current sensor) or power (Watts as measured by a power sensor) as a proxy for auger torque. In some cases, a variable frequency drive (VFD) for the auger motor 128 can have data outputs indicating motor torque based on current sensors in the VFD. Parameters directly or indirectly indicating torque are referred to herein as torque-indicating parameters. Any means for providing data regarding the value of torque-indicating parameters is referred to as a sensor 1111. In a standard operation, auger torque can change slowly as the product inventory in the treatment tank increases at the start of operation and decreases as product is emptied from the treatment tank at the end of operations.

The value of the ATIP relates to several other independent parameters. In many applications, the product 304 can sink in treatment liquid 106, and the product can settle to the bottom of the tank 102. In such applications, ATIP can increase as total product inventory increases due to friction between the product 304 and the tank wall 161 and between the product and auger flight 122. ATIP can decrease as liquid level 196 rises since the liquid can partially buoy the product. Once the product is fully covered by treatment liquid, ATIP does not change as liquid level rises further. ATIP generally decreases with increased agitation fluid flow to the extent that agitation suspends product in the treatment liquid 106. ATIP can be affected by the composition of the treatment liquid 106 to the extent that such composition alters the coefficient of friction between the product 304 and the tank wall 161 and auger flight 122. The ATIP can increase as viscosity of the treatment liquid 106 increases due to fluid drag on the auger flight 122, though this effect can be negligible in many examples. Increasing the speed of rotation of the auger 104 can ultimately reduce ATIP by shortening the residence time and consequently the total product inventory in the tank 102, though this effect can be somewhat slow to develop.

In other applications, the product 304 can float or be neutrally buoyant in the treatment liquid 106. In such applications the correlation between ATIP and total product inventory can still be positive though less pronounced with the increase in ATIP being caused primarily by increase in effective viscosity of the mixture of product 304 and treatment liquid 106.

An unloader-torque-indicating parameter (UTIP) characterizing the torque required to operate the unloader 107 in the auger treatment tank 100 can be used as a process measurement 921, as a metric 1001, and as a control output 918. The UTIP can be measured using the same types of sensors described for the ATIP. Unloader torque can vary as the position of the unloader changes-particularly in the case of a paddlewheel-type unloader 107a. Consequently, a characteristic unloader torque measured at a particular position can be established for use in the control algorithms.

An auger speed parameter characterizing the rotational speed of the auger 104 can be used in various ways including as a metric 1001, as a process measurement 921, and as a control output 918. The auger speed can be measured directly by a rotation sensor 439. In the non-limiting example illustrated in FIG. 4, a cogged disc 424 is attached to and rotates with the auger drive shaft 436. As the drive shaft rotates, cogs and spaces between cogs alternately pass in front of a proximity sensor which detects the presence of a cog. By timing the interval between one cog passing and the next, speed can be calculated. Other types of speed sensor are readily available and can be employed with similar results. In some embodiments, the speed of the auger motor 128, the power frequence supplied to the motor, or any other quantity directly related to the speed of the auger 104 can be used as the auger speed parameter.

Controls 1112 for controlling auger speed can include a variable frequency drive (VFD) for the auger motor 128, a variable speed reducer or transmission or other speed altering mechanisms incorporated into the auger drive 126. The auger speed can vary over time.

A treatment time parameter characterizing the amount of time the product 304 spends in the auger treatment tank 100 can be used in various ways including as a metric 1001, as a process measurement 921, and as a control output 918. Auger treatment tanks 100 generally preserve the sequence in which product is introduced into the tank such that product is deposited into the inlet end 103 of the treatment tank and spends a specific amount of time (treatment time) traveling to the outlet end 105 where it is unloaded. The treatment time can be calculated from the structure and rotational speed of the auger 104. The structure of the auger is characterized by the number of times the auger flight 122 wraps around the auger shaft 140. Treatment time can refer to the number (which can be a fractional number) of revolutions the flight makes around the shaft divided by the average auger speed expressed in revolutions per minute. For this calculation, the auger speed can be averaged over the duration of the treatment time.

Treatment time can be controlled by adjusting the auger speed as previously described.

A product infeed rate parameter characterizing the rate at which product 304 is deposited in the auger treatment tank 100 can be used in various ways including as a process measurement 921, a metric 1001, and as a control output 918. The infeed rate can be measured by a weight-indicating sensor (e.g., a scale) associated with product infeed conveyance such as a shackle line 702. In other embodiments, the infeed rate can be measured by counting units of product 304 using a product sensor 708 as the product enters the auger treatment tank 100. In other embodiments, the infeed conveyance might be a belt conveyor or screw conveyor or other types of conveyance.

A product unloading rate parameter characterizing the rate at which product 304 is unloaded from the auger treatment tank 100 can be used in various ways including as a metric 1001, a control output 918, and as a process measurement 921. The unloading rate can be measured (i.e., an example of a means for determining a rate at which the product is being unloaded) by a scale 718 (also called a weight-indicating sensor) associated with product discharge conveyor 702. In other embodiments, the unloading rate can be measured (i.e., an example of a means for determining a rate at which the product is being unloaded) by counting units of product 304 using a product sensor such as a vision recognition sensor as the product passes down a discharge chute 114. In other embodiments, the unloading rate can be calculated (i.e., an example of a means for determining a rate at which the product is being unloaded) from the UTIP as the unloader paddles 111 lift the product 304 out of the auger treatment tank 100.

The unloading rate can be regulated by adjusting the auger speed as previously described. Increasing the auger speed increases the rate at which product 304 is presented to the unloader 107. When the unloader is running properly, it can remove all the product presented by the auger 104 without causing product to back up in the auger treatment tank 100.

An unloader speed parameter characterizing the rate at which the unloader 107 moves can be used in various ways including as a process measurement 921, a metric 1001, and as a control output 918. An unloader rotation sensor 514 detects movement of the unloader shaft 306. Components for sensing movement can comprise a Hall effect proximity switches adjacent to a cogged disk 510 attached to the unloader drive shaft 306 or optical encoders, or other sensors. The unload speed can be measured directly by a paddle proximity sensor 516 as illustrated in FIG. 5. The paddle proximity sensor 516 can detect paddles 111 as they pass the sensor. By timing the interval between passing paddles, unloader speed can be calculated. Other types of speed sensors are readily available and can be employed with similar results. In some embodiments, the speed of the unloader motor 502, the power frequence supplied to the motor, or any other quantity directly related to the speed of the unloader 107 can be used as the unload speed parameter.

Controls 1112 for controlling unloader speed can include a variable frequency drive (VFD) for the unloader motor 502, a variable speed reducer or transmission or other speed altering mechanisms incorporated into the unloader drive. The unloader speed can vary over time.

A total product inventory parameter characterizing the total amount of product 304 present in the auger treatment tank 100 can be used as a process measurement 921, as a metric 1001, and as a control output 918. The total product inventory can be calculated by integrating the infeed rate less the unloading rate over time starting when product 304 is first added to an empty auger treatment tank 100. An alternate calculation method is to integrate the infeed rate only over a time interval equal to the treatment time. The total product inventory determined by the second method applies at the end of the integration interval. In other embodiments, the total product inventory can be estimated based on the ATIP with adjustment for liquid level 196, friction factors and possibly other considerations. For any particular design of an auger treatment tank 100, there is a product capacity parameter which is the maximum recommended total product inventory that can completely fill the tank in a manner that still allows for effective treatment. Product capacity is usually limited by the volume of the tank.

The total product inventory need not be uniformly distributed along the length of the auger treatment tank 100. A local product load parameter characterizing the amount of product 304 present in a relatively short contiguous length of the auger treatment tank 100 can be used as a process measurement 921, a metric 1001, and a control output 918. The length of the auger treatment tank 100 occupied by the local product load can be an arbitrary dimension e.g., one foot, or it can correspond to a compartment 730 previously described. Local product load can be calculated by integrating the infeed rate over a time interval required for the auger 104 to move product the reference distance. In the example given where the reference distance corresponds to a compartment 730, the integration time is the time required for the auger to make one revolution. The local product load thus calculated applies at the end of the integration interval and is applicable until that compartment 730 has traveled to the outlet end 105 of the auger treatment tank 100 and has been unloaded.

The maximum local product load is the highest value of local product load that has been calculated during the immediate past time interval equal to the treatment time. The maximum local product load quantifies the amount of product in any one compartment 730 or reference unit length anywhere in the auger treatment tank 100. The product capacity for the auger treatment tank 100 can be divided by the length of the tank to get a local product capacity for a unit length of the tank. Alternatively, the product capacity can be divided by the number of compartments 730 formed by the auger 104 to determine a compartment capacity. It is recommended that the maximum local product load not exceed the local product capacity.

A product temperature parameter characterizing the temperature of the product 304 can be used in various ways including as a metric 1001 and as a process measurement 921, and as a control output 918. The temperature most often of interest to the treatment tank operator is the core temperature of a unit of product as it is unloaded from the auger treatment tank 100. Core temperature can be measured by sampling product as it is unloaded from the auger treatment tank 100 and inserting a temperature probe into the product 304. The inserted temperature probe can be a network sensor 1111 or it can be an isolated sensor in which case the temperature values can be entered into the data store 1113 manually. In some cases, product temperature can be measured at places in the product treatment tank other than the unloader 107. In some cases, surface temperature of units of product can provide useful information and be easier to obtain, for example using an infrared temperature sensor 720. In some embodiments, the product temperature can be estimated or inferred based on process attributes such as treatment time, agitation fluid flow, liquid level 196, initial product temperature, treatment liquid 106 temperature, unit size of the product and other relevant parameters.

The product temperature can be adjusted by managing several other parameters. During treatment, the product 304 temperature moves toward the treatment liquid 106 temperature which can be higher or lower than the initial product temperature. Changing the treatment liquid 106 temperature can alter the product temperature. Several factors can drive the product 304 temperature to be closer to the treatment liquid 106 temperature. Without limitation, these factors can include one or more: increasing treatment time, increasing agitation fluid flow, increasing the treatment liquid level 196 to fully cover product 304 in the tank and increasing the circulation of treatment liquid 106 through the auger treatment tank 100 as with a circulation pump 612, or any combination thereof.

An agitation fluid flow parameter characterizing the flow rate of agitation fluid into the auger treatment tank 100 can be used in various ways including as a metric 1001, as a process measurement 921 and as a control output 918. As previously noted, the agitation fluid can be air or treatment liquid 106 or another fluid injected into the auger treatment tank 100 for the purpose of increasing circulation of the treatment liquid 106 about the product 304. Agitation fluid flow can be measured directly using an agitation flow sensor 220. In other embodiments, agitation fluid flow can be expressed in terms of the supply pressure of the agitation fluid. In other embodiments, agitation fluid flow can be expressed in terms of the speed of blowers or pumps used to supply the agitation fluid.

Agitation fluid flow can be adjusted by an agitation flow control valve 154. In other embodiments, agitation fluid flow can be adjusted by changing the speed of blowers or pumps used to supply the agitation fluid.

An anomalous stress parameter characterizing the potential for physical damage to the auger treatment tank 100 can be used in various ways including as a metric 1001, as a control output 918, and as a process measurement 921. Torque is applied to the auger 104 to overcome resistance to rotation of the auger. In the standard operation, the resistance is primarily generated by friction between the product 304 and the auger flight 122 and between the product and the tank wall 161. The equipment is designed to withstand the stress of such loading. Prior art auger treatment tanks sometimes employ torque limiting devices such as shear pins to prevent damage to the equipment should the torque applied to the auger exceed the expected torque for a system fully loaded with product. However, such methods fail to protect against localized damage when the total product inventory in the auger treatment tank 100 is less than the product capacity. The classic example of such a situation is when a temporary access ladder is inadvertently left in the tank and the auger is started. In the process of crushing the ladder, the auger treatment tank 100 can incur localized damage to its auger flight 122 and possibly other components as well. Should this happen before the treatment tank 100 is filled with product 304, it is likely that the auger torque would never exceed the torque limit for the whole system.

The anomalous stress parameter can comprise the difference between the expected value of ATIP and the actual current value. For example, if the ATIP exceeds a value expected for the current operating condition, the excess torque can counteract forces due to anomalous stress or resistance that has not been accounted for previously. The expected value would take into account the current operating condition of the auger treatment system as characterized by parameters that can include total product inventory, maximum local product load, treatment liquid level 196, the size and design of the auger 104 and tank 102 and potentially other parameters. The expected value of ATIP can be generated by a performance model 915 or a forecast model 909. In other embodiments, the expected value of ATIP can be calculated from relatively simple equations in a control application 1115. Similar analysis can be applied to UTIP.

In other embodiments, the anomalous stress parameter can comprise a rate of change in ATIP. In the standard operation, auger torque changes slowly as the product inventory in the treatment tank increases at the start of operation and, as the standard operation progresses, the product inventory in the treatment tank decreases as product is emptied. A sudden or rapid increase in ATIP usually indicate unexpected circumstances which can cause damage and should be investigated.

Treatment liquid 106 temperature can be characterized by two parameters. The controlled liquid temperature parameter characterizing the temperature of treatment liquid following temperature adjustment. A controlled liquid temperature parameter can be used in various ways including as a process measurement 921, as a metric 1001, and as a control output 918. In embodiments wherein the treatment liquid 106 is circulated through an external heat exchanger 614, the functional settings of the heat exchanger 614 can be adjusted to control the temperature of liquid leaving the heat exchanger 614. The value of controlled liquid temperature can be determined for example as measured by a controlled liquid temperature sensor 618. For embodiments in which the temperature of treatment liquid 106 is manipulated in situ, the liquid temperature at the coolest location of tanks 102 wherein the liquid is cooled or the warmest location of tanks 102 wherein the liquid is warmed, for example as measured by sensor 406 can serve as the controlled liquid temperature. Temperatures can be taken in other locations in other embodiments.

Treatment liquid 106 temperature can be further characterized by a tank liquid temperature parameter characterizing the condition of treatment liquid 106 in the tank 102. It can be an average of measurements from several locations, or it can be the warmest or coldest temperature, or it can be the temperature measured at a single, consistent location. In some embodiments, it can be desirable to mount temperature sensors in locations where they are protected from buffeting by product in the tank 102. Examples of such locations include a suction box 156 or overflow box 142 such as temperature sensor 406.

Referring to FIGS. 9 and 10, a set of performance metrics 1001 defines and quantifies the processor's objectives in treating the product. Examples of performance metrics might include product attributes such as product temperature, product texture or tenderness, asepsis, pH, or degree of curing. Other metrics might include process attributes such as treatment time, unloading rate (product delivery rate), treatment liquid level 196, treatment liquid composition or anomalous stress (damage potential). For example, the processor might have an objective of delivering a certain quantity of product each minute to the next processing step downstream of the treatment tank 100 with scheduled breaks in delivery in order to maintain the overall production schedule for the facility. The applicable performance metric would be unloading rate (i.e., the rate at which the unloader 107 removes product 304 from the auger treatment tank 100). These and other possible metrics are further described herein. The spirit and methods of this invention are applicable to other metrics relevant to particular treatment processes. The processor arbitrarily sets performance setpoints 903 (i.e., desired values for performance metrics) which setpoints can change over the course of operations as represented in FIG. 9.

The auger treatment tank 100 includes one or more physical controllable elements (such as pumps, valves, motors, etc.) that can be adjusted to alter operation of the auger treatment tank 100. Such controllable elements are usually regulated by a control 1112 such as a solenoid or motor operator for a valve and a contactor or starter or VFD for a motor. A controller 927 generates control outputs 918 that are communicated to controls 1112 to perform actions that regulate operation of the respective controllable element. Some control outputs have analog values (e.g., motor speed, weir height) while others can be discrete (e.g., on/off, open/closed). Control outputs can generally be assigned arbitrary values within a range of allowed values. Some or all control outputs 918 can be under optimized control meaning that the control algorithm 900 dynamically adjusts the value of such parameters as treatment conditions evolve. The remaining control outputs can be under manual control or static control meaning that the control algorithm sets the control output to a particular value at the start of operations but does not continuously adjust the value as treatment conditions evolve. Non-limiting examples of control outputs 918 can include auger motor 128 speed, unloader motor 502 speed, agitation flow control valve 154, circulation pump 612 speed, transfer pumps 606, liquid supply valve 620, drain valve 624 and weir linear actuator 802.

The objective of automated control is to set the optimized control outputs 918 to values that cause performance metrics to conform most closely to the established performance setpoints 903. FIG. 9 shows an optimizer algorithm 906 setting the control output values 918 that should provide the best treatment performance. The optimizer 906 works iteratively with a forecast model 909 of the auger treatment tank 100 to select control output values. Herein, the optimizer 906 and forecast model 909 are collectively referred to as a controller 927. Typically, the control output values 918 can be applied for a fixed amount of time referred to as a time step before being updated for subsequent time steps.

The forecast model 909 is an algorithm that uses parameter values from the current operating condition of the treatment tank along with trial control outputs from the optimizer 906 to estimate the future condition of the auger treatment tank 100 and product 304 for the next one or more time steps. The estimate includes forecast values for performance metrics.

At each time step, the optimizer 906 generates multiple sets of trial values for the control outputs and sends them to the forecast model 909 which returns forecast values of the performance metrics. The set of control outputs 918 that generate performance metric values that best match the performance setpoints 903 is selected for use in the next time step.

Some of the parameters used to represent the current operating condition can be measured directly as process measurements 921. Other parameters—referred to as derivatives—can be difficult to measure directly but can be calculated or estimated from process measurements 921. The performance model 915 is an algorithm for generating derivatives.

Static factors 924 in FIG. 9 represent parameters that do not change or change infrequently but are nonetheless useful for calculating derivatives and performance metrics. For example, the liquid holding capacity of the particular treatment tank 102 expressed as a function of liquid level 196 is useful in calculating certain derivatives and performance metrics. Such static factors can be entered by the operator as the need arises.

The production schedule 912 in FIG. 9 represents the possibility that the production schedule for the processing facility can be used to improve the accuracy of the forecast model 909. For example, the production schedule 912 can call for product to be loaded into the treatment tank 100 at a particular rate over a particular time period after which no product will be loaded for the next time interval. Factoring such information into the forecast would reduce forecast error around the time of such transitions. Schedule information can be entered manually by an operator or transferred from an information network in the facility.

In some applications, acceptable treatment performance can be achieved with a significantly reduced set of optimized control outputs 918. For example, forecast model 909 predictions for the performance metrics product internal temperature and liquid level 196 can be dominated by the derivative parameter maximum local product load (defined hereafter) to the extent that all other factors can be ignored. In such situations, the controller 927 can be simplified from an optimizer 906 and forecast model 909 algorithm to a set of feedback functions 1001 to set control outputs 918 for treatment liquid level 196 based on maximum local product load. In some embodiments, the feedback functions 1001 can be PID control loops. In some embodiments, control liquid level 196 can be achieved by adjusting the height of an adjustable standpipe 144. Other control outputs (including makeup flow, dasher speed, liquid temperature, etc.) can be manually or automatically adjusted on a relatively infrequent basis such as hourly, daily or at need.

FIG. 10 represents a feedback-type optimizer algorithm 900b in which two optimized control outputs 918 are controlled by independent feedback loops 1006 based on respective performance metrics 1001. More or less than two feedback loops can be employed as desired for the particular application in question. Effectively, the optimizer 906 and forecast model 909 of FIG. 9 have been simplified to an alternate controller 927 comprising a set of one or more feedback control loops. As noted earlier, there can be additional controllable elements that are controlled statically. Further comparison with FIG. 9 shows that optimized control outputs 918 and performance setpoints 903 are illustrated individually. Performance metrics 1001 are illustrated explicitly. Note that performance setpoints 903 are specific values of their respective metrics and can vary over time.

As alluded above, the performance metrics 1001 employed for the simplified system can be different than those suggested in the discussion of FIG. 9. While parameters such as product internal temperature and tenderness are still of primary interest to the processor, certain derivative parameters such as maximum local product load can be used as a proxy for those primary metrics. Each performance metric 1001 of FIG. 10 can be a process measurement 921 or any derivative constructed or extrapolated from measurements 921 or a primary performance metric 1001 of interest to the processor provided that the value of the parameter 1001 used is separable from the influence of other control outputs 918. Said another way, the value of each performance metric 1001 of FIG. 10 can be relatively independent of control outputs 918 other than the one it is looped with. Specific combinations of performance metrics 1001 and control outputs 918 are discussed further herein.

The circle elements 1006 of FIG. 10 represent control algorithms. These algorithms can be any variant of a PID control loop or a predictive control algorithm or any other type of single-output control algorithm. Various categories of parameters and individual parameters are described in more detail below, providing quantities of interest for optimizing product treatment.

With reference to FIG. 11, shown is a networked environment 1100 according to various embodiments. The networked environment 1100 includes a computing environment 1103, one or more client devices 1106, and one or more auger treatment tanks 100, which can be in data communication with each other via a network 1109. The network 1109 includes, for example, the Internet, intranets, extranets, wide area networks (WANs), local area networks (LANs), wired networks, wireless networks, cable networks, satellite networks, or other suitable networks, etc., or any combination of two or more such networks. The auger treatment tanks 100 are instrumented as described with a programmable logic controller (PLC) 1110 that is connected to a plurality of sensors 1111 and a plurality of controls 1112. The various sensors 1111 can include any of the sensors discussed with respect to the various figures. In other examples, the auger treatment tanks 100 can include a computing device such as a server computer, embedded computing system, and so on, directly connected to the sensors 1111 and the controls 1112.

The computing environment 1103 can comprise, for example, a server computer, a PLC, an embedded computing device, or any other system providing computing capability. Alternatively, the computing environment 1103 can employ a plurality of computing devices that can be arranged, for example, in one or more server banks or computer banks or other arrangements. Such computing devices can be located in a single installation or can be distributed among many different geographical locations. For example, the computing environment 1103 can include a plurality of computing devices that together can comprise a hosted computing resource, a grid computing resource, and/or any other distributed computing arrangement. In some cases, the computing environment 1103 can correspond to an elastic computing resource where the allotted capacity of processing, network, storage, or other computing-related resources can vary over time.

Various applications and/or other functionality can be executed in the computing environment 1103 according to various embodiments. Also, various data is stored in a data store 1113 that is accessible to the computing environment 1103. The data store 1113 can be representative of a plurality of data stores 1113 as can be appreciated. The data stored in the data store 1113, for example, is associated with the operation of the various applications and/or functional entities described below.

The components executed on the computing environment 1103, for example, include a treatment tank control application 1115 and other applications, services, processes, systems, engines, or functionality not discussed in detail herein. The treatment tank control application 1115 is executed to manage and optimize the operation of the auger treatment tank 100 that has been instrumented with the sensors 1111 and the controls 1112. For example, the treatment tank control application 1115 can implement a Supervisory Control and Data Acquisition (SCADA) system in conjunction with the PLC 1110, where the client devices 1116 do not have direct access to sensors 1111 and controls 1112.

The data stored in the data store 1113 can include, for example, a production schedule 912, one or more static factors 924, one or more control output values 918, one or more performance metrics 1001, one or more process measurements 921, one or more derivative parameters 1131, historical data 1133, one or more forecast models 909, and potentially other data.

The production schedule 912 can include data describing a schedule for delivery of raw product to the auger treatment tank 100 and delivery of treated product to further processing operations downstream of the treatment tank including scheduled interruptions (breaks) and changes in rate of delivery. The production schedule 912 can also include scheduled changes in product properties, which can affect the type of treatment to be provided in the auger treatment tank 100. For example, larger product can require longer treatment times, while smaller product can require shorter treatment times. The production schedule 912 can also document the availability of manual operators to intervene and make manual adjustments.

The static factors 924 correspond to factors important to precise control of the auger treatment tank 100 but which do not change appreciably during the course of daily operation. However, these factors can vary widely from one application to another, and such variation can alter the form of mathematical expressions used to characterize some of the dynamic factors and functions disclosed herein. The physical size and shape of the auger treatment tank 100 can influence the way product responds to treatment processes and informs the preferred control algorithms. The auger treatment tank 100 can be characterized by internal length, width or diameter and maximum liquid depth (distance from bottom of tank to liquid level).

Changes in the composition of treatment liquid 106 can change the viscosity of the liquid or the friction coefficient between the product and tank 102 surfaces. Such changes can skew the dynamics of the auger treatment tank 100. A treatment liquid composition correction factor can be applied to compensate for periodic alteration of the treatment liquid recipe. Values for the correction factor can be determined experimentally and cataloged for various treatment liquid 106 recipes.

The static factors 924 can also include product characteristics, such as unit weight, specific gravity of the product, thermal conductivity of the product, and so on. The unit weight corresponds to the mass of an individual units or pieces of product. The specific gravity of the product determines whether product sinks, floats or is neutrally buoyant in the treatment liquid 106. The thermal conductivity of the product affects how long it takes to add or remove heat from the interior of product units.

Various performance metrics 1001 can be monitored by way of the sensors 1111 and optimized by way of the controls 1112. For example, performance metrics 1001 can include a treated product delivery schedule or unloading rate, a treated product core temperature, treatment time, and/or other metrics. For simplified control systems, internal temperature or other treated product attributes can be assumed to be met if the delivery schedule and treatment time are maintained.

The process measurements 921 can include readings from the sensors 1111. For example, the process measurements 921 can include a product infeed rate, a tank liquid temperature, a tank liquid level 196, auger torque, unloader torque, controlled liquid temperature, auger speed, unloader speed, product weight, product internal temperature, position indications, and so on. Process measurements 921 can be used as performance metrics 1001.

The derivative parameters 1131 can include parameters that are calculated based upon process measurements 921, control output values 918, static factors 924, the production schedule 912, and/or other data. Non-limiting examples of derivative parameters 1131 can include auger torque (in embodiments in which torque is not measured directly), product inventory in tank, unloading rate, treatment time, local product load, product internal temperature, product yield, and agitation intensity. Derivative parameters 1131 can be used as performance metrics 1001.

The historical data 1133 can include historical values for production schedules 912, static factors 924, control output values 918, performance metrics 1001, process measurements 921, and derivative parameters 1131 for the same auger treatment tank 100 or other auger treatment tanks 100. The historical data 1133 can be used as training data for a machine learning algorithm used to generate the forecast model 909 and/or to optimize the performance metrics 1001. Machine learning algorithms can involve linear regression, logistic regression, K-means clustering, gradient descent, and others.

The client device 1106 can be representative of a plurality of client devices 1106 that can be coupled to the network 1109. The client device 1106 can include, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client device 1106 can include a display comprising, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 1106 can be configured to execute various applications such as a client application 1148 and/or other applications. The client application 1148 can be executed in a client device 1106, for example, to access network content served up by the computing environment 1103 and/or other servers, thereby rendering a user interface on the display. To this end, the client application 1148 can include, for example, a browser, a dedicated application, etc., and the user interface can include a network page, an application screen, etc. The client device 1106 can be configured to execute applications beyond the client application 1148 such as, for example, email applications, social networking applications, word processors, spreadsheets, and/or other applications.

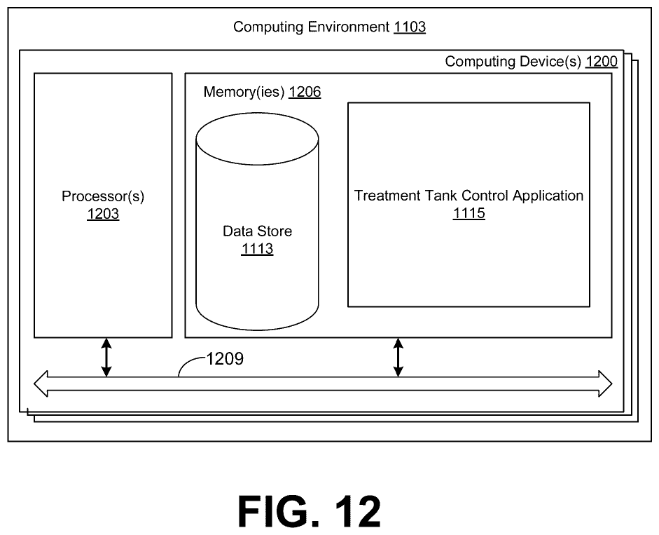

With reference to FIG. 12, shown is a schematic block diagram of the computing environment 1103 according to an embodiment of the present disclosure. The computing environment 1103 includes one or more computing devices 1200. Each computing device 1200 includes at least one processor circuit, for example, having a processor 1203 and a memory 1206, both of which are coupled to a local interface 1209. To this end, each computing device 1200 can include, for example, at least one server computer or like device. The local interface 1209 can include, for example, a data bus with an accompanying address/control bus or other bus structure as can be appreciated.

Stored in the memory 1206 are both data and several components that are executable by the processor 1203. In particular, stored in the memory 1206 and executable by the processor 1203 are the treatment tank control application 1115 and potentially other applications. Also stored in the memory 1206 can be a data store 1113 and other data. In addition, an operating system can be stored in the memory 1206 and executable by the processor 1203.

It is understood that there can be other applications that are stored in the memory 1206 and are executable by the processor 1203 as can be appreciated. Where any component discussed herein is implemented in the form of software, any one of a number of programming languages can be employed such as, for example, C, C++, C#, Objective C, Java®, JavaScript®, Perl, PHP, Visual Basic®, Python®, Ruby, Flash®, or other programming languages.

A number of software components are stored in the memory 1206 and are executable by the processor 1203. In this respect, the term “executable” means a program file that is in a form that can ultimately be run by the processor 1203. Examples of executable programs can be, for example, a compiled program that can be translated into machine code in a format that can be loaded into a random access portion of the memory 1206 and run by the processor 1203, source code that can be expressed in proper format such as object code that is capable of being loaded into a random access portion of the memory 1206 and executed by the processor 1203, or source code that can be interpreted by another executable program to generate instructions in a random access portion of the memory 1206 to be executed by the processor 1203, etc. An executable program can be stored in any portion or component of the memory 1206 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1206 is defined herein as including both volatile and nonvolatile memory and data storage components. Volatile components are those that do not retain data values upon loss of power. Nonvolatile components are those that retain data upon a loss of power. Thus, the memory 1206 can include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can include, for example, static random access memory (SRAM), dynamic random access memory (DRAM), or magnetic random access memory (MRAM) and other such devices. The ROM can include, for example, a programmable read-only memory (PROM), an erasable programmable read-only memory (EPROM), an electrically erasable programmable read-only memory (EEPROM), or other like memory device.

Also, the processor 1203 can represent multiple processors 1203 and/or multiple processor cores and the memory 1206 can represent multiple memories 1206 that operate in parallel processing circuits, respectively. In such a case, the local interface 1209 can be an appropriate network that facilitates communication between any two of the multiple processors 1203, between any processor 1203 and any of the memories 1206, or between any two of the memories 1206, etc. The local interface 1209 can include additional systems designed to coordinate this communication, including, for example, performing load balancing. The processor 1203 can be of electrical or of some other available construction.

Although the treatment tank control application 1115 and other various systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the treatment tank control application 1115, that includes software or code can be embodied in any non-transitory computer-readable medium for use by or in connection with an instruction execution system such as, for example, a processor 1203 in a computer system or other system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including, for example, static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein, including the treatment tank control application 1115, can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device 1200, or in multiple computing devices 1200 in the same computing environment 1103.

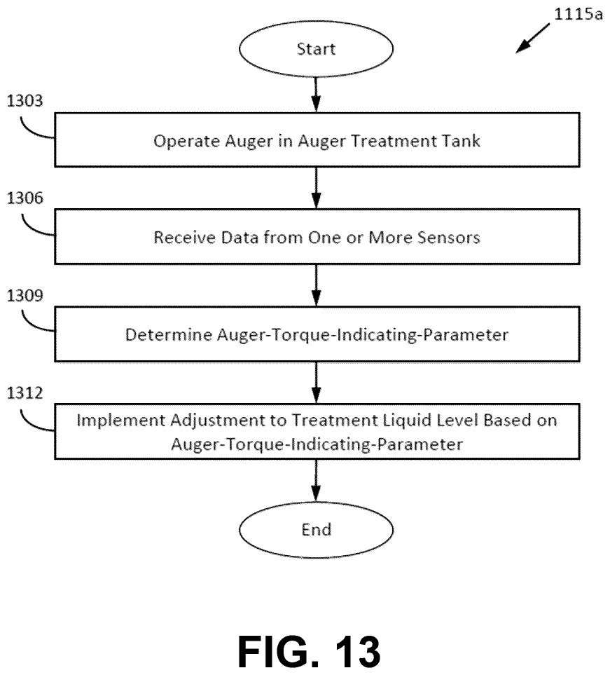

FIGS. 13-17 show flowcharts that illustrate various examples of the operation of a portion of the treatment tank control application 1115 according to various embodiments. It is understood that these flowcharts do not describe the complete functionality of a control application 1115 whether the figures are taken individually or collectively. Instead, they are intended to highlight novel features of the current disclosure. The various features thus illustrated can be, but need not be, combined in any particular embodiment of an auger treatment tank 100. It is further understood that these figures merely provide examples of the many different types of functional arrangements that can be employed to implement the operation of the portion of the treatment tank control application 1115 as described herein. As an alternative, the flowcharts of FIGS. 13-17 can be viewed as depicting examples of elements of a method implemented in the computing environment 1103 (FIG. 11) according to one or more embodiments.

Referring to FIG. 13, shown is a flowchart that provides one example of the operation of a portion of a treatment tank control application 1115a according to various embodiments. This portion of the application addresses control of the liquid level 196. Beginning with box 1303, the treatment tank control application 1115a operates an auger 104 in an auger treatment tank 100. Operation of the auger 104 can include causing it to rotate within the treatment liquid 106 as previously described. The speed of rotation can be static or dynamic as these terms have been defined herein.

In box 1306, the treatment tank control application 1115a receives data from one or more sensors 1111. One or more of the sensors are configured to provide data directly or indirectly indicating a torque transmitted to the auger 104 to effect rotation as previously disclosed regarding an auger-torque-indicating parameter (ATIP). The sensors 1111 can include one or more sensors configured to directly or indirectly measure a treatment liquid level 196 in the auger treatment tank 100 as previously disclosed in regard to the liquid level parameter. The sensors 1111 can include one or more sensors to detect product infeed or unloading rate from the auger treatment tank 100 as previously disclosed in regard to a product inventory parameter.

In box 1309, the treatment tank control application 1115a determines an ATIP based at least in part on the data received from the one or more sensors 1111. Various means for determining the ATIP have been described previously in this disclosure.

In box 1312, the treatment tank control application 1115a implements an adjustment to the treatment liquid level 196 in the auger treatment tank 100 based at least in part on the ATIP. In one embodiment, the adjustment is implemented in response to the ATIP meeting a threshold determined by a machine learning model. For example, a machine learning model can be trained based upon data describing optimized operation of the auger treatment tank 100, and the machine learning model can yield a threshold for the auger-torque-indicating parameter such that when the estimated auger torque or a related parameter exceeds or falls beneath a threshold, the level of the treatment liquid 106 is automatically adjusted.

In another embodiment of the treatment tank control application 1115a, a performance model 915 can estimate an expected value for ATIP base at least in part on the total product inventory parameter and current liquid level 196. If the actual (i.e., measurement based) ATIP is higher than expected, the control application 1115a can implement an adjustment 1312 to liquid level 196 by changing control outputs 918 as previously disclosed in regard to the liquid level parameter. Thereafter, the operation of the portion of the treatment tank control application 1115a ends.

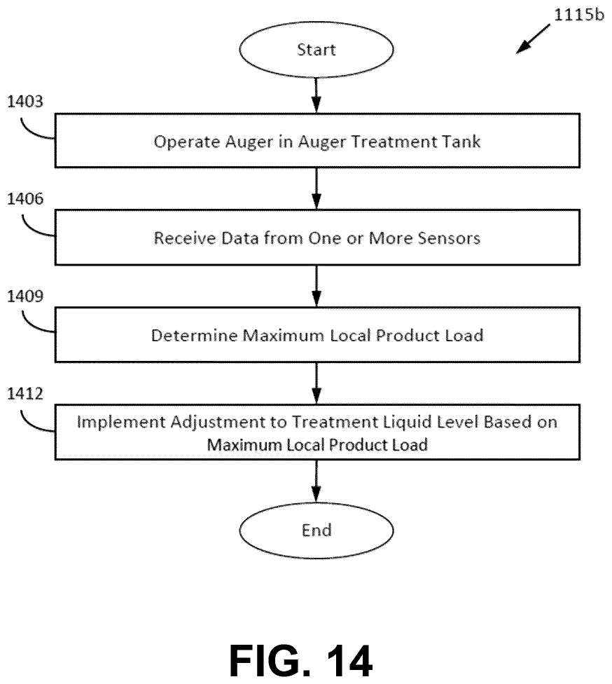

Referring next to FIG. 14, shown is a flowchart that provides one example of the operation of another portion of the treatment tank control application 1115b according to various embodiments. This portion of the application addresses other means of control of the liquid level 196. Beginning with box 1403, the treatment tank control application 1115b operates an auger 104 in an auger treatment tank 100. Operation of the auger 104 can include causing it to rotate within the treatment liquid 106 as previously described. The speed of rotation can be static or dynamic as these terms have been defined herein.

In box 1406, the treatment tank control application 1115b receives data from one or more sensors 1111. One or more of the sensors are configured to provide data directly or indirectly indicating a product infeed rate to the auger treatment tank 100 as previously disclosed in regard to a product infeed rate parameter. The sensors 1111 can include one or more sensors configured to directly or indirectly measure a product unloading rate from the auger treatment tank 100 as previously disclosed in regard to an unloading rate parameter. The sensors 1111 can include one or more sensors configured to directly or indirectly measure the speed of the auger 104 as previously disclosed regarding the auger speed parameter. The sensors 1111 can include one or more sensors configured to directly or indirectly measure a treatment liquid level 196 in the auger treatment tank 100 as previously disclosed in regard to the liquid level parameter. The sensors 1111 can include one or more sensors to provide data directly or indirectly indicating a torque transmitted to the auger 104 to effect rotation as previously disclosed regarding an auger-torque-indicating parameter (ATIP).

In box 1409, the treatment tank control application 1115b determines a maximum local product load based at least in part on the data received from the one or more sensors 1111 by means previously disclosed regarding a maximum local product load parameter.

Given that the purpose of the auger treatment tank 100 is to effect some change in the product 304 by immersing the product in treatment liquid, it is generally desired that the liquid level 196 be sufficient to cover all the product contained in the treatment tank. However, as the treatment liquid 106 can be valuable, it is also desired to avoid excessive consumption of treatment liquid. In box 1412, the treatment tank control application 1115b implements an adjustment to the liquid level 196 based at least in part on the maximum local product load parameter. In one embodiment, a liquid level setpoint 903 is established by a machine learning model. For example, a machine learning model can be trained based upon data describing optimized operation of the auger treatment tank 100, and the machine learning model can yield a liquid level setpoint 903 based at least in part on the maximum local product load currently experienced in the auger treatment tank 100. The control application 1115b would generate control outputs 918 necessary to achieve the liquid level setpoint 903. The control outputs 918 would be directed toward one or more of the various means for adjusting the liquid level 196 previously disclosed with regard to the liquid level parameter.

In another embodiment of the treatment tank control application 1115b, a setpoint 903 for the liquid level 196 can be determined by calculating the volume that the maximum local product load would occupy when covered by treatment liquid and then calculating the liquid level 196 that such a volume would occupy in the particular geometry of the tank 102. Additional parameters can be considered to refine the liquid level setpoint. Control outputs 918 would be generated as discussed in the preceding paragraph. Thereafter, the operation of the portion of the treatment tank control application 1115b ends.

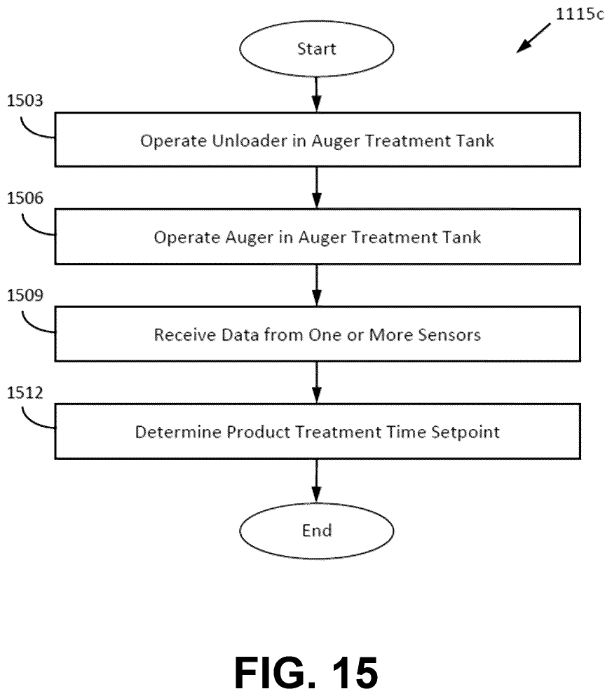

Referring next to FIG. 15, shown is a flowchart that provides one example of the operation of another portion of the treatment tank control application 1115c according to various embodiments. This portion of the application addresses determination of a treatment time setpoint 903. Beginning with box 1503, the treatment tank control application 1115c operates an unloader 107 in an auger treatment tank 100. Operation of the unloader 107 can include causing it to move in a manner that removes treated product 304 from the tank 102 and presents the treated product 304 to the next processing step following immersion treatment. Various types of unloader 107 and their operation have previously been described.

In box 1506, the treatment tank control application 1115c operates an auger 104 in an auger treatment tank 100. Operation of the auger 104 can include causing it to rotate within the treatment liquid 106 as previously described. The speed of rotation is dynamic as this term has been defined herein.

In box 1509, the treatment tank control application 1115c receives data from one or more sensors 1111. Depending upon the treatment objectives of a particular application of the auger treatment tank 100, various data can be useful. The sensors 1111 can include one or more sensors configured to directly or indirectly measure a treatment liquid level 196 in the auger treatment tank 100 as previously disclosed in regard to the liquid level parameter. The sensors 1111 can include one or more sensors to provide data directly or indirectly indicating a product temperature as previously disclosed regarding product temperature parameter. The sensors 1111 can include one or more sensors to provide data directly or indirectly indicating other product attributes such as product texture or tenderness, asepsis, pH, or degree of curing that can be of interest in a particular application. The sensors 1111 can include one or more sensors to provide data directly or indirectly indicating a treatment liquid temperature such as temperature sensor 406 or agitation flow such as flow sensor 220. The sensors 1111 can include one or more sensors to provide data directly or indirectly indicating treatment liquid composition factors such as pH or chemical composition or concentration or other such properties of interest.

In box 1512, the treatment tank control application 1115c determines a treatment time setpoint 903 based at least in part on the data received from the one or more sensors. Depending upon the treatment objectives of a particular application of the auger treatment tank 100, various data can be used in determining the treatment time setpoint 903. For example, in some embodiments, the temperature of product 304 being unloaded can be a primary objective. In this case, the treatment tank control application 115c would receive data from an infrared temperature detector 720 for example or other sensors as previously disclosed regarding a product temperature parameter. If the product temperature is too hot or too cold, the treatment time setpoint 903 would be adjusted as described next. As described in the previous paragraph, parameters other than product temperature can be of interest in alternate embodiments in which case other sensors 1111 and/or parameters can be used alone or in combination to determine a treatment time setpoint 903.

In one embodiment, a treatment time setpoint 903 is established by a machine learning model. For example, a machine learning model can be trained based upon data describing optimized operation of the auger treatment tank 100, and the machine learning model can yield a treatment time setpoint 903 based at least in part on the product temperature currently experienced in the auger treatment tank 100. The treatment tank control application 115c can also employ static factors 924 and derivative parameters 1131 in determining the treatment time setpoint 903.

In another embodiment, the control application 1115c determines process measurements 921 based on one or more sensors 1111. A performance model 915 and/or a forecast model 909 can receive data from process measurements 921 and/or static factors 924 to generate a treatment time setpoint 903. Thereafter, the operation of the portion of the treatment tank control application 1115c ends.

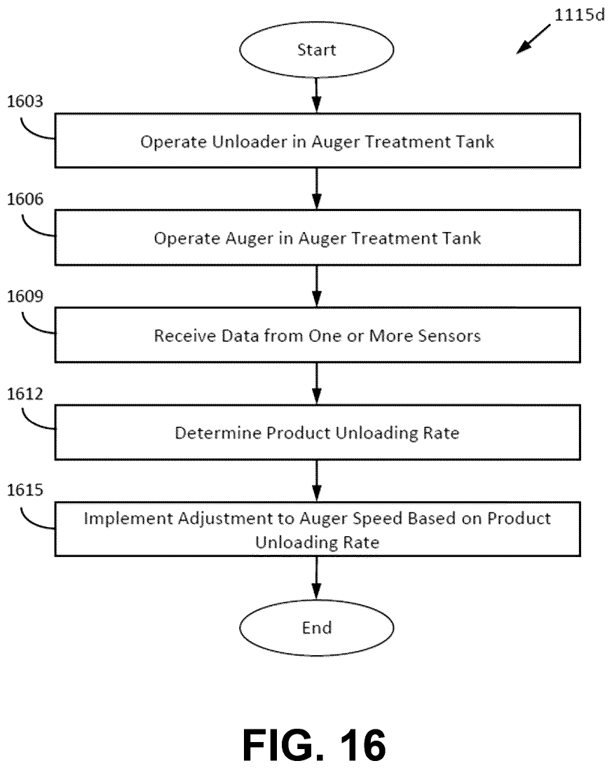

The treatment tank control application 1115c can implement an adjustment to the auger speed based at least in part on the treatment time set point 903. The control application 1115c would generate control outputs 918 directed toward one or more of the controls 1112 for adjusting auger speed previously disclosed with regard to an auger speed parameter. Referring next to FIG. 16, shown is a flowchart that provides one example of the operation of another portion of the treatment tank control application 1115d according to various embodiments. This portion of the application addresses control of the auger speed. The process steps of boxes 1603 and 1606 are analogous to boxes 1503 and 1506, respectively. In box 1609, the treatment tank control application 1115d receives data from one or more sensors 1111. One or more of the sensors are configured to provide data directly or indirectly indicating a product unloading rate from the auger treatment tank 100 as previously disclosed in regard to a product unloading rate parameter. Otherwise, the sensors 1111 are analogous to those disclosed in regard to box 1509.

In box 1612, the treatment tank control application 1115d determines a product unloading rate based at least in part on the data received from the one or more sensors 1111. Various means for determining the unloading rate have been described previously in this disclosure.

In some embodiments of the auger treatment tank 100, it is desirable to unload product 304 at a steady rate over the duration of one revolution of the auger 104. This generally occurs naturally when compartments 730 are full of product. However, when compartments are not full (i.e., when the local product load is less than the compartment capacity), surging can occur. Surging can occur when product is not uniformly distributed in a compartment 730. More product can be piled against the face of the section of auger flight 122 on the inlet side of the compartment while the area behind the downstream section of auger flight 122 can be relatively empty. When the auger 104 turns at a steady rate, the unevenly distributed of product is presented to the unloader 107 in surges.

To mitigate surging, the auger speed can be varied over the duration of one revolution such that the auger speed is higher when lightly loaded sections of a compartment 730 are presented to the unloader 107, and the auger speed is lower when heavily loaded sections of a compartment are presented to the unloader. Note that it can be desirable to maintain the average auger speed over the span of a full revolution consistent with the requirements for treatment time as disclosed in regard to FIG. 15. In box 1615, the treatment tank control application 1115d adjusts the auger speed based at least in part on the product unloading rate. Various means for adjusting auger speed have been disclosed in regard to the auger speed parameter. Thereafter, the operation of the portion of the treatment tank control application 1115d ends.

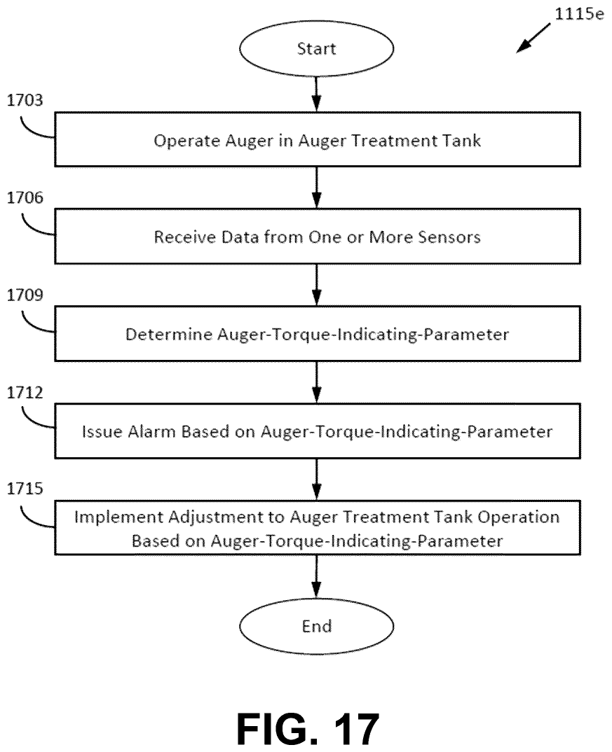

Referring next to FIG. 17, shown is a flowchart that provides one example of the operation of another portion of the treatment tank control application 1115e according to various embodiments. This portion of the application addresses detecting and avoiding damage to the auger treatment tank 100. Beginning with box 1703, the treatment tank control application 1115e operates an auger 104 in an auger treatment tank 100. Operation of the auger 104 can include causing it to rotate within the treatment liquid 106 as previously described. The speed of rotation can be static or dynamic as these terms have been defined herein.

In box 1706, the treatment tank control application 1115e receives data from one or more sensors 1111. One or more of the sensors are configured to provide data directly or indirectly indicating a torque transmitted to the auger 104 to effect rotation as previously disclosed regarding an auger-torque-indicating parameter (ATIP). The sensors 1111 can include one or more sensors configured to directly or indirectly measure a treatment liquid level 196 in the auger treatment tank 100 as previously disclosed in regard to the liquid level parameter. The sensors 1111 can include one or more sensors to detect product infeed rate and unloading rate from the auger treatment tank 100 as previously disclosed in regard to a product inventory parameter. The sensors 1111 can include one or more sensors to detect auger speed of the auger 104 in the auger treatment tank 100 as previously disclosed in regard to an auger speed parameter.

In box 1709, the treatment tank control application 1115e determines an ATIP based at least in part on the data received from the one or more sensors 1111. Various means for determining the ATIP have been described previously in this disclosure.

In box 1712, the treatment tank control application 1115e implements one or more alarms triggered at least in part by the ATIP. One type of alarm might be a high-torque alarm indicating that the auger torque is approaching or exceeding the design limit of the auger 104 or of some component in the auger drive 126. Alarm thresholds are preferably expressed in the same units of measure as the ATIP. Alarm thresholds can represent the design limit or can be reduced by some safety margin. For example, the alarm threshold can represent 90% of the design limit. The design limits or other alarm thresholds can be stored in the data store 1113 as static factors 924.

Another type of alarm can be characterized as an anomalous stress alarm. The treatment tank control application 1115e determines an anomalous stress parameter as previously disclosed. For example, in some embodiments, the anomalous stress parameter can include the difference between the expected value of ATIP and the actual current value. The treatment tank control application 1115e can generate an expected value of ATIP. Should the actual current value (i.e., measurement based value) of ATIP exceed the expected value by more than a threshold amount, an anomalous stress alarm would be issued.

In other embodiments, the anomalous stress parameter can include a rate of change in ATIP. It can be appreciated that such an anomalous stress parameter is based at least in part on ATIP. Should the anomalous stress parameter exceed a threshold value, an anomalous stress alarm would be issued. For example, the threshold can represent the highest rate of change in ATIP expected during the standard operation.

In some embodiments, the expected value of ATIP and the various thresholds cited can be determined by a machine learning model. For example, a machine learning model can be trained based upon data describing optimized operation of the auger treatment tank 100, and the machine learning model can yield an expected value for ATIP consistent with the training data. Likewise, the machine learning model can yield a threshold for the anomalous stress parameter such that when anomalous stress exceeds—or in some cases falls beneath—the threshold, an anomalous stress alarm is issued.

In another embodiment of the treatment tank control application 1115e, a performance model 915 and/or forecast model 909 can estimate an expected value for ATIP base at least in part on process measurements 921 derived from the one or more sensors 1111, static factors 924 and/or derivative parameters 1131.

In box 1715, the treatment tank control application 1115e implements adjustments to an operation of the auger treatment tank 100 based at least in part on the ATIP. The parameters applied and analyzed can be identical and/or include at least some of those discussed in regard to box 1712. The thresholds applied can have slightly different values such that alarms are issued before corrective adjustments are made to operations in order to give operators time to intervene.

In one embodiment, an adjustment to auger treatment tank 100 operation can include stopping the auger 104 if the ATIP exceeds a threshold for example by deenergizing the auger motor 128. This and other adjustments described herein are achieved by appropriate changes to the relevant control outputs 918 as previously disclosed. In another embodiment, an adjustment to auger treatment tank 100 operation can include increasing the auger speed if the ATIP exceeds a threshold for example by increasing or decreasing the speed of auger motor 128. In another embodiment, an adjustment to auger treatment tank 100 operation can include increasing the liquid level 196 if the anomalous stress parameter exceeds a threshold by one of the means for changing liquid level 196 previously disclosed in regard to a liquid level parameter. Other changes such as changes to agitation fluid flow can be appropriated in some embodiments. Thereafter, the operation of the portion of the treatment tank control application 1115e ends.

The structure and methodology represented by FIG. 17 can likewise be applied to analysis of a UTIP to detect and avoid damage to the unloader 107.

The flowcharts of FIGS. 13-17 show the functionality and operation of an implementation of portions of the treatment tank control application 1115. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor 1203 in a computer system or other system. The machine code can be converted from the source code, etc. If embodied in hardware, each block can represent a circuit or a number of interconnected circuits to implement the specified logical function(s).

Although the flowcharts of FIGS. 13-17 show a specific order of execution, it is understood that the order of execution can differ from that which is depicted. For example, the order of execution of two or more blocks can be scrambled relative to the order shown. Also, two or more blocks shown in succession in FIGS. 13-17 can be executed concurrently or with partial concurrence. Further, in some embodiments, one or more of the blocks shown in FIGS. 13-17 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, the following is claimed:

1. An auger treatment tank, comprising:
an auger configured to rotate within treatment liquid in the auger treatment tank, the auger comprising at least one auger flight coupled to and helically disposed about an auger shaft;
one or more sensors configured to provide data directly or indirectly indicating a torque transmitted to the auger to effect rotation; and
at least one processor configured to at least partially control operation of the treatment tank and to at least:
determine a value of an auger-torque-indicating parameter based at least in part on the data received from the one or more sensors;
determine an anomalous stress parameter for the auger treatment tank based at least in part on a current operating condition and the value of the auger-torque-indicating parameter; and
automatically perform an action based at least in part on the anomalous stress parameter, the action comprising at least one of: issuing a warning or alarm associated with the anomalous stress parameter, modifying operation of the auger treatment tank to ameliorate the anomalous stress parameter, or any combination thereof.

2. The auger treatment tank of claim 1, wherein the at least one processor is further configured to at least:
determine a rate of change in the value of the torque-indicating parameter; and
determine the anomalous stress parameter for the auger treatment tank based at least in part on the rate of change of the value of the torque-indicating parameter.

3. The auger treatment tank of claim 1, wherein the action comprises generating a control output corresponding to at least one of an auger motor speed, an unloader motor speed, an agitation flow control valve, a circulation pump speed, a transfer pump control, a liquid supply valve control, a drain valve control, a weir actuator control, or any combination thereof.

4. An auger treatment tank for treating a product by immersion in a treatment liquid, comprising:
an unloader configured to lift treated product out of the treatment tank;
one or more sensors configured to provide data directly or indirectly indicating a torque transmitted to the unloader to effect movement; and
at least one processor configured to at least partially control operation of the treatment tank and to at least:
determine a value of an unloader-torque-indicating parameter based at least in part on the data received from the one or more sensors;
determine an anomalous stress parameter to the auger treatment tank based at least in part on a current operating condition and the value of the unloader-torque-indicating parameter; and
automatically perform an action based at least in part on the anomalous stress parameter, the action comprising at least one of: issuing a warning or alarm associated with the anomalous stress parameter, modifying operation of the auger treatment tank to ameliorate the anomalous stress parameter, or any combination thereof.

5. The auger treatment tank of claim 4, wherein the at least one processor is further configured to at least:
determine a rate of change in the value of the unloader-torque-indicating parameter; and determine the anomalous stress parameter for the auger treatment tank based at least in part on the rate of change of the value of the unloader-torque-indicating parameter.

6. The auger treatment tank of claim 4, wherein the action comprises generating a control output corresponding to at least one of an auger motor speed, an unloader motor speed, an agitation flow control valve, a circulation pump speed, a transfer pump control, a liquid supply valve control, a drain valve control, a weir actuator control, or any combination thereof.

7. An auger treatment tank for treating a product by immersion in a treatment liquid, comprising:
an auger configured to rotate within the treatment liquid in the auger treatment tank, the auger comprising at least one auger flight coupled to and helically disposed about an auger shaft;
one or more auger-torque-indicating sensors configured to provide data directly or indirectly indicating a torque transmitted to the auger to effect rotation; and
at least one processor configured to at least:
determine a value of an auger-torque-indicating parameter based at least in part on the data received from the one or more auger-torque-indicating sensors; and
determine a treatment liquid level setpoint for the auger treatment tank based at least in part on the value of the auger-torque-indicating parameter.

8. The auger treatment tank of claim 7 in which the at least one processor is further configured to automatically adjust the amount of treatment liquid in the auger treatment tank to achieve the treatment liquid level setpoint.

9. The auger treatment tank of claim 7, wherein:
the auger treatment tank further comprises one or more liquid-level-indicating sensors configured to provide data directly or indirectly indicating a treatment liquid level in the auger treatment tank; and
the at least one processor is further configured to at least:
determine a current treatment liquid level in the auger treatment tank based at least in part on the data received from the one or more liquid-level-indicating sensors; and
determine the treatment liquid level setpoint for the auger treatment tank based at least in part on the current treatment liquid level.

10. The auger treatment tank of claim 9, wherein:
the auger treatment tank further comprises means to determine a quantity of product resident in the auger treatment tank; and
the at least one processor is further configured to at least:
determine a value of a parameter indicating the quantity of product based at least in part on the means to determine the quantity of product; and
determine the treatment liquid level setpoint for the auger treatment tank based at least in part on the value of the parameter indicating the quantity of product.

11. An auger treatment tank for treating a product by immersion in a treatment liquid, comprising:
an unloader configured to move within the treatment liquid in the auger treatment tank and to lift treated product out of the treatment tank;
an auger configured to rotate within the treatment liquid in the auger treatment tank and to convey the product through the treatment liquid toward the unloader, the auger comprising at least one auger flight coupled to and helically disposed about an auger shaft;
means for determining a rate at which product is being unloaded from the auger treatment tank; and
at least one processor configured to at least:
control a speed of rotation of the auger;
determine an unloading rate at which product is being unloaded from the auger treatment tank based at least in part on the means provided; and
automatically adjust the speed of rotation the auger to control a rate at which product is pushed toward the unloader based at least in part on the unloading rate at which product is being unloaded.

12. The auger treatment tank of claim 11, wherein:
the means for determining the unloading rate at which product is being unloaded from the auger treatment tank comprises one or more unloader-torque-indicating sensors configured to provide data directly or indirectly indicating a torque transmitted to the unloader to effect movement; and
the at least one processor is further configured to:
determine a value of an unloader-torque-indicating parameter based at least in part on the data received from the one or more unloader-torque-indicating sensors; and
determine the unloading rate at which product is being unloaded from the auger treatment tank based at least in part on the value of the unloader-torque-indicating parameter.

13. The auger treatment tank of claim 11, wherein:
the means for determining the unloading rate at which product is being unloaded from the auger treatment tank comprises one or more weight-indicating sensors configured to weigh the product as or after it is unloaded from the auger treatment tank; and
the at least one processor is further configured to determine the unloading rate at which product is being unloaded from the auger treatment tank based at least in part on data received from the one or more weight-indicating sensors.

14. The auger treatment tank of claim 11, wherein:
the means for determining the unloading rate at which product is being unloaded from the auger treatment tank comprises one or more sensors configured to count a number of units of product as or after the product is unloaded from the auger treatment tank; and
the at least one processor is further configured to determine the unloading rate at which product is being unloaded from the auger treatment tank based at least in part on data received from the one or more counting sensors.

15. An auger treatment tank for treating a product by immersion in a treatment liquid, comprising:
an unloader configured to remove treated product from the auger treatment tank;
an auger configured to rotate within the treatment liquid in the auger treatment tank and to convey the product through the treatment liquid toward the unloader, the auger comprising at least one auger flight coupled to and helically disposed about an auger shaft;
means for determining a temperature of product as or immediately after it is unloaded from the auger treatment tank; and
at least one processor configured to at least:
control a speed of rotation of the auger;
measure, based at least in part on the means for determining a temperature of product, the temperature of product as the product is unloaded or immediately after the product is unloaded from the auger treatment tank; and
automatically adjust, in response to measuring the temperature of the product, the speed of rotation of the auger to control a conveyance rate at which product is conveyed toward the unloader.

16. The auger treatment tank of claim 15, wherein:
the means for determining the temperature of the product comprises one or more infrared temperature sensors configured to sense product temperature; and
the at least one processor is further configured to determine the temperature of the product based at least in part on data received from the one or more infrared temperature sensors.

17. The auger treatment tank of claim 15, wherein:
the means for determining the temperature of the product comprises insertion of a temperature sensor into the product and recording a measurement; and
the at least one processor is further configured to determine the temperature of the product based at least in part on recorded data received or identified based at least in part on the inserted temperature sensor.

18. The auger treatment tank of claim 1, wherein the one or more sensors comprises at least one strain gauge coupled to the auger drive shaft.

19. The auger treatment tank of claim 1, wherein the one or more sensors comprises at least one current sensor that measures a drive motor current for the auger.

20. The auger treatment tank of claim 1, wherein:
the auger treatment tank further comprises one or more sensors configured to provide data related to the operating condition of the auger treatment tank; and
the at least one processor is further configured to at least:
determine the operating condition of the auger treatment tank and an expected value of the auger-torque-indicating parameter; and
determine the anomalous stress parameter based at least on comparison of the value of the auger-torque-indicating parameter and the expected value of the auger-torque-indicating parameter.
